(19) United States
(12) Patent Application Publication
(10) Pub. No.: US 2013/0246641 A1
(43) Pub. Date: Sep. 19, 2013

(54) METHOD AND APPARATUS FOR DYNAMIC SERVER CLIENT CONTROLLED CONNECTIVITY LOGIC

(71) Applicant: NOKIA CORPORATION, Espoo (FI)

(72) Inventors: Markku VIMPARI, Oulu (FI); Jukka S. Ala-Kontiola, Oulu (FI); Zexian Li, Espoo (FI); Simo P. Veikkolainen, Masala (FI)

(73) Assignee: Nokia Corporation, Espoo (FI)

(21) Appl. No.: 13/773,902

(22) Filed: Feb. 22, 2013

Related U.S. Application Data
(60) Provisional application No. 61/602,861, filed on Feb. 24, 2012.

(51) Int. Cl. H04L 12/70

(52) U.S. Cl. CPC H04L 47/10
USPC 709/228

(57) ABSTRACT

The exemplary embodiments of the invention provide at least a method and apparatus to receive a connection instruction request from a user equipment; identify a network from which the request was sent; select stored probe values and associated network information that are associated with the identified network; determine connection instructions based at least in part on the stored probe values and the associated network information, in which the connection instructions include a dynamically extended reconnection delay if a determined keep-alive timer for keep-alive instructions would be impractically short; and send the connection instructions to the user equipment. Further, the exemplary embodiments of the invention provide at least a method and apparatus to determine a maximum packet size for which transmission will not trigger a state change for user equipment; and restrict transmissions of background data to or from the user equipment so as not to exceed the maximum packet size.

### CROSS-REFERENCE TO RELATED APPLICATIONS

This patent application claims priority under 35 U.S.C. §119(e) from U.S. Provisional Patent Application No. 61/602,861 filed Feb. 24, 2012, the disclosure of which is incorporated by reference herein in its entirety.

### TECHNICAL FIELD

The teachings in accordance with the exemplary embodiments of this invention relate generally to at least determining connection instructions based at least in part on the stored probe values and the associated network information, and to determining a maximum packet size for which transmission will not trigger a state change for a user equipment and restricting transmissions of background data so as not to exceed the maximum packet size.

### BACKGROUND

Service providers and device manufacturers are continually challenged to deliver value and convenience to consumers by, for example, providing compelling network services. Important differentiators in the industry are application and network services as well as connectivity of the services. In particular, keep-alive timers are used by internet protocol applications in devices to send keep-alive packets to keep a connection open to a server on a public internet or keep a device connected to an access network. Inadequate keep-alive timer values can lead to the loss of connections or when sent too often, into excessive power consumption.

Particularly in the developing countries there are congested cellular access networks where attempting to use always on connection during the busy hours yields to periodic loss of connection and reconnection or very frequent keep-alive packets both causing extensive battery consumption for mobile clients and a high load for at least the access network.

In addition, network devices such as personal computers (PCs) run a range of applications can communicate in the background without end-user interaction. These communications include, among other things, “always-on” services and/or applications such as, for example, instant messaging (IM), PoC (push-to-talk over cellular), Push e-mail, and keep-alive messages. In addition, secure connections, such as virtual private network connections, can also require that packets of data (e.g., keep alive packets) are transmitted infrequently and/or intermittently in the background. It can be seen that these types of transmission/reception requirements can also lead to excessive use of resources and power consumption.

### SUMMARY

Therefore, there is a need for an approach for informing devices of optimal keep-alive timer values or in some special cases to delay reconnection after the connection has been lost or voluntarily disconnect instead of keeping the connection alive with keep-alive packets sent impractically often.

According to one embodiment, a method comprises receiving a request to measure one or more probe values that relate to a keep-alive timer value associated with a network. The method also comprises determining to measure whether the one or more probe values comprise one or more successful probe values, one or more unsuccessful probe values of either lost probe packets or detection of the connection to be lost before sending the next probe packet, or a combination thereof. The keep-alive timer, dynamically extended re-connection delay or voluntary disconnection instead of using keep-alive, or a combination thereof is determined based, at least in part, on a statistical analysis of the one or more probe values.

According to another embodiment, an apparatus comprising at least one processor, and at least one memory including computer program code for one or more programs, the at least one memory and the computer program code configured to, with the at least one processor, cause the apparatus to receive a request to measure one or more probe values that relate to a keep-alive timer value or dynamically extended reconnection delay or voluntary disconnection instead of keep-alive packets associated with a network. The apparatus is further caused to determine to measure whether the one or more probe values comprise one or more successful probe values, one or more unsuccessful probe values of either lost probe packets or detection of the connection to be lost before sending the next probe packet, or a combination thereof. The keep-alive timer, dynamically extended reconnection delay or voluntary disconnection instead of keep-alive packets, or a combination thereof is determined based, at least in part, on a statistical analysis of the one or more probe values.

According to another embodiment, a computer-readable storage medium carrying one or more sequences of one or more instructions which, when executed by one or more processors, cause an apparatus to receive a request to measure one or more probe values that relate to a keep-alive timer value, dynamically extended reconnection delay or voluntary disconnection instead of keep-alive packets associated with a network. The apparatus is further caused to determine to measure whether the one or more probe values comprise one or more successful probe values, one or more unsuccessful probe values of either lost probe packets or detection of the connection to be lost before sending the next probe packet, or a combination thereof. The keep-alive timer, dynamically extended reconnection delay or voluntary disconnection instead of keep-alive packets, or a combination thereof is determined based, at least in part, on a statistical analysis of the one or more probe values.

According to another embodiment, an apparatus comprises means for receiving a request to measure one or more probe values that relate to a keep-alive timer value or dynamically extended reconnection delay or voluntary disconnection instead of keep-alive packets associated with a network. The apparatus further comprises means for determining to measure whether the one or more probe values comprise one or more successful probe values, one or more unsuccessful probe values of either lost probe packets or detection of the connection to be lost before sending the next probe packet, or a combination thereof. The keep-alive timer, dynamically extended reconnection delay or voluntary disconnection instead of keep-alive packets, or a combination thereof is determined based, at least in part, on a statistical analysis of the one or more probe values.

According to another embodiment, a method comprises receiving a connection instruction request from a user equipment; identifying a network from which the request was sent; selecting stored probe values and associated network information that are associated with the identified network; determining connection instructions based at least in part on the stored probe values and the associated network information, in which the connection instructions include a dynamically extended reconnection delay if a determined keep-alive timer for keep-alive instructions would be impractically short; and sending the connection instructions to the user equipment.

According to another embodiment, there is an apparatus comprising: at least one processor; and at least one memory including computer program code, where the at least one memory and the computer program code are configured, with the at least one processor, to cause the apparatus to at least: receive a connection instruction request from a user equipment; identify a network from which the request was sent; select stored probe values and associated network information that are associated with the identified network; determine connection instructions based at least in part on the stored probe values and the associated network information, in which the connection instructions include a dynamically extended reconnection delay if a determined keep-alive timer for keep-alive instructions would be impractically short; and send the connection instructions to the user equipment.

In accordance with another embodiment, there is a method comprising determining a maximum packet size for which transmission will not trigger a state change for a user equipment; and restricting transmissions of background data to or from the user equipment so as not to exceed the maximum packet size.

In accordance with yet another embodiment, there is an apparatus comprising: at least one processor; and at least one memory including computer program code, where the at least one memory and the computer program code are configured, with the at least one processor, to cause the apparatus to at least: determine a maximum packet size for which transmission will not trigger a state change for a user equipment; and restrict transmissions of background data to or from the user equipment so as not to exceed the maximum packet size.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of transmitting optimal keep-alive timer values, dynamically extended reconnection delays or recommendation of voluntary disconnection instead of keeping the connection alive with keep-alive packets, or a combination thereof, according to one embodiment;

FIG. 2 is a diagram of the components of a user equipment that can utilize optimal keep-alive timer values dynamically extended reconnection delays or recommendation of voluntary disconnection instead of keeping the connection alive with keep-alive packets, or a combination thereof, according to one embodiment;

FIG. 3A is a flowchart of a process for utilizing optimal keep-alive timer values, dynamically extended reconnection delays or recommendation of voluntary disconnection instead of keeping the connection alive with keep-alive packets, or a combination thereof according to one embodiment;

FIG. 3B is a flowchart of a process for an adaptive data transmission scheme in accordance with the exemplary embodiments of the invention;

FIG. 4 is a diagram of a host hardware that can be used to implement an embodiment of the invention;

FIG. 5 is a diagram of a service platform comprising one or more hosts of FIG. 4 that can be used to implement an embodiment of the invention;

FIG. 6 is a diagram of a mobile station (e.g., handset) that can be used to implement an embodiment of the invention;

FIG. 7 is a diagram illustrating a re-connect timer behavior in accordance with an embodiment of the invention;

FIG. 8A is a diagram illustrating communications of devices and/or components in accordance with an exemplary embodiment of the invention;

FIG. 8B is a diagram illustrating connectivity decisions in accordance with an exemplary embodiment of the invention; and

FIGS. 9A and 9B are each a flow chart illustrating a method in accordance with the exemplary embodiments of the invention.

### DESCRIPTION OF SOME EMBODIMENTS

A method, apparatus, and software for probe service providing optimal keep-alive timer values, dynamically extended reconnection delays or recommendation of voluntary disconnection instead of keeping the connection alive with the said keep-alive packets, or a combination thereof are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

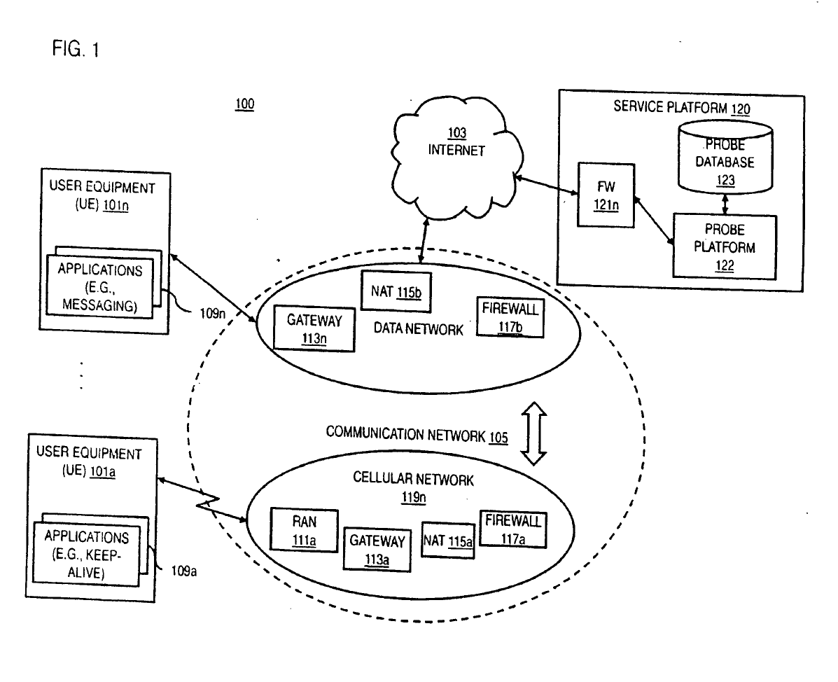

FIG. 1 is a diagram of a system capable of transmitting optimal keep-alive timer values, dynamically extended reconnection delays or recommendation of voluntary disconnection instead of keeping the connection alive with the said keep-alive packets, or a combination thereof, according to one embodiment. Under the scenario of FIG. 1, a system 100 involves user equipment (UE) 101 having connectivity to a service platform 120 over a communication network 105 and public interne 103. The service platform 120 can provide keep-alive time values, dynamically extended reconnection delays or recommendation of voluntary disconnection instead of keeping the connection alive with the said keep-alive packets, or a combination thereof for the UE 101 to stay connected, delay re-connection or voluntary disconnect instead of keeping the connection alive with the said keep-alive packets to a network by utilizing a probe platform 122. A keep-alive application 109a on the UE 101 can access the probe platform 122 to receive the keep-alive timer values, recommendations to delay re-connection or voluntary disconnect instead of keeping the connection alive with the said keep-alive packets and to update the probing service. Other applications, such as a messaging application 109n or an e-mail application (not shown) can also be executed on the UE 101 and utilize the optimal keep-alive time value, be synchronized to the delayed re-connection or voluntary disconnection following by a delayed re-connection at a later time. The maximum message delivery latency characteristics indicated by the applications 109 affect the UE 101 decision how it utilize the keep alive timer value, dynamically extended reconnection delay or recommendation of voluntary disconnection instead of keeping the connection alive, or a combination thereof.

In one embodiment, services, like the messaging application 109n, use keep-alive timers to stay connected to a service platform 120. Various points (e.g., the Radio Access Network (RAN) 111a containing base stations and radio network controllers (not shown), a gateway 113a-113n, a network address translation (NAT) 115a-115n, a firewall 117a-117n, etc.) of the network can drop a UE 101 connection. Each of these points can have different inactivity timer values, which can correspond to the keep-alive maximum timer values. In devices like a UE 101, it is advantageous to keep the keep-alive timer value longer, delay re-connections or even in some cases voluntary disconnect instead of keeping the connection alive if it would requiring impractically short keep-alive period. In some embodiments, the optimal value is close to the maximum time. On the route through the various points, the shortest inactivity timer of a route is the effective inactivity timer value. The timers along the route are different because different manufacturers make the different device points and different network administrators manage the different device points. Both the RAN 111a and NAT 115a maybe drop the connections under heavy load using temporally shortened inactivity timers. In one embodiment, the UE 101 is a cellular device. In many cases, there is a firewall 117 or a NAT 115 between the cellular UE 101 connected to a cellular network 119 via RAN 111 and a data network 103 (e.g. internet). In another embodiment, there is a firewall 117 or NAT 115 between a UE 101n and a service platform 120. Because the gateway 113 a firewall 117 and a NAT 115 are stateful devices, each drops packets received from the public internet that are not belonging to any TCP stream or virtual UDP connection opened by a UE 101. In wired local area networks, sending constant keep-alive packets only marginally affects the power consumption of the UE 101. However, in a cellular network 119 comprising RAN 111 setting, keep-alive timer settings can have a drastic effect on the standby life of a UE 101. For example a UE 101 with a continuous connection and a sub-optimal keep-alive timer value may have a standby time of 10 hours while a UE 101 with a continuous connection and an optimal keep-alive timer value may have a standby time of 4 days.

Keeping the connection alive pedantically is extremely problematic if the RAN 111 closes the connection or if the NAT 115 drops the packets due being overloaded and high number of UEs 101 attempt to reconnect automatically. In addition to the short operation time of battery powered devices and thus poor end user experience, the automatically reconnecting UEs 101 increase the network load and drives the RAN 111 or NAT 115 into even deeper congestion.

To address this problem, a system 100 of FIG. 1 introduces the capability to determine a statistically determined optimal keep-alive timer value, dynamically extended reconnection delay or recommendation of voluntary disconnection instead of keeping the connection alive, or a combination thereof for UEs 101 based on the connections of the UE 101. In this embodiment, UEs 101 can obtain information about optimal keep alive containing but not limited to the keep-alive timer value and delay before re-connection in case of the network connection is lost parameters using a keep-alive application 109a. In another embodiment, the UEs 101 are behind the same gateway 113. In one embodiment, a keep-alive application 109a of a UE 101 requests a keep-alive timer value, dynamically extended reconnection delay or recommendation of voluntary disconnection instead of keeping the connection alive, or a combination thereof for the network that the UE 101 is connected to. In this embodiment, a probe platform 122 responds to the keep-alive application 109a with a keep-alive timer value, dynamically extended reconnection delay or recommendation of voluntary disconnection instead of keeping the connection alive, or a combination thereof determined by processing information in a probe database 123. In one embodiment, if the probe database 123 has insufficient or stale information, the probe platform 122 can request that the UE 101 be a probe for gathering information.

In one embodiment, a connection includes a RAN 111, a gateway 113, a NAT 115, a firewall 117, other connection devices, or a combination thereof. These connection devices can be used to connect a UE 101 to a service platform 120. Some applications (e.g., instant messaging, e-mail or social network application) on the UE 101 use connections that should be constantly live to receive updates from a service platform 120. Multiple devices can be used for routing a connection from a UE 101 to an endpoint service provider. Each of the devices may keep a connection alive for a certain period of time according to an inactivity timer value. If the connection of the UE 101 is inactive for longer than the inactivity timer value, the connection is dropped. The connection can be dropped by any one of these devices used in routing the connection. The connection devices can be more efficient with shorter inactivity timer values because the connection devices can reuse resources. However, a longer inactivity timer value would be advantageous to a UE 101 because it would mean less keep-alive packets need to be sent, saving power. The UE 101 can use a keep-alive timer value to send a packet (e.g., an empty packet, a data packet, etc.) to keep a connection alive. In some embodiments, the UE 101 can keep a connection alive for multiple applications 109 using a single keep-alive packet.

In the case RAN 111 or NAT 115 are configured to use impractically short inactivity timers, or due a congestion using temporally shortened inactivity timers, the UE can based on the data received from the probe platform 122, delay the re-connection after having detected the connection to being lost, voluntary disconnect instead of keeping the connection alive and reconnect after the said dynamically extended re-connection delay, or a combination thereof.

In one embodiment, the service platform 120 includes a probe database 123. The probe database 123 may contain information that can facilitate a probe platform 122 in determining a proper keep-alive timer value, dynamically extended reconnection delay or recommendation of voluntary disconnection instead of keeping the connection alive, or a combination thereof for a UE 101 that requests one. In one embodiment, the probe database 123 includes information about the specific communication network 105. For binding the connection from the UE 101 into the communication network specific information, the request from the UE 101 can include a mobile country code (MCC), a mobile network code (MNC), an interne protocol source address, a cellular identifier, a gateway (e.g., a gateway general packet radio service support node (GGSN)), an access point name, or the like. In one embodiment, an access point name (APN) can be used to identify a GPRS bearer service. In one embodiment, the probe database 123 includes data collected about the connections, such as keep-alive timer values from probes, and keep-alive timer values from probes that have been determined to being lost, and detected dropped connection before sending the next probe packet. Additionally, the probe database 123 can store historical and current keep-alive timer values from probes. Historical keep-alive timer values can be used to keep track of changes to inactivity timer values, dynamically extended reconnection delay or recommendation of voluntary disconnection instead of keeping the connection alive, or a combination thereof set by a connection (e.g. a connection can set a shorter inactivity timer value as well as extended delayed re-connection delay or even recommend voluntary disconnection instead of keeping the connection alive during peak usage hours, a connection can set a shorter inactivity timer value during holidays, or other patterns).

In one embodiment, the service platform 120 includes a probe platform 122. The probe platform 122 can determine optimal keep-alive timer values, dynamically extended reconnection delays or recommendations of voluntary disconnection instead of keeping the connection alive, or a combination thereof for a UE 101 depending on the communication network serving the UE 101. In one embodiment, the probe platform 122 maps RAN 111 or gateway 113 (such as a GGSN) timer values based on a MCC or MNC. The MCC and MNC values can identify a network provider or a location associated with the connection of the UE 101. In one embodiment, this information can be used to map a connection to an operator. In some embodiments, the equipment and inactivity timing patterns can be determined through statistical analysis. In another embodiment, the probe platform 122 can map gateway/GGSN 113 inactivity timer inactivity values based on cellular identifiers or the source internet protocol address determined, the internet protocol source sub network determined, or a combination thereof from the request. In one embodiment, the probe platform 122 can map RAN 111, a gateway 113, NAT 115 or a combination of the three based on this information. In some embodiments, a combination of connection information is used to determine optimal keep-alive timer values, dynamically extended reconnection delays or recommendations of voluntary disconnection instead of keeping the connection alive, or a combination thereof for the UE 101.

In one embodiment, the service platform 120 receives a request for a keep-alive timer value, possible dynamically extended reconnection delays, recommendations of voluntary disconnection instead of keeping the connection alive, or a combination thereof for a specific network. The service platform 120 queries a probe database 123 to for information regarding the connection. In one embodiment, the probe database 123 knows the successful keep-alive probe values, unsuccessful probe timer values and the times of detected lost connection since previous successful probe packets sent and received for the communication network. In this embodiment, the service platform 120 initiates transmission of the optimal keep-alive timer value, dynamically extended reconnection delays or recommendations of voluntary disconnection instead of keeping the connection alive, or a combination thereof to the UE 101. In another embodiment, the probe database 123 has information about the earlier measurement data in that particular communication network, but the optimal keep-alive timer value, dynamically extended reconnection delays or recommendations of voluntary disconnection instead of keeping the connection alive, or a combination thereof is determined using some statistical analysis. In this embodiment, the probe platform 122 can receive current and historical probe values from a probe database 123. In one embodiment, the probe values include good probe values that represent probe values that have maintained a successful connection, and failed probe values that represent probe values that have been unsuccessful, and times when the connection was determined to be closed e.g. to the RAN 111 after the successful probe packets sent and received. In one embodiment, the probe platform 122 filters out the tail values of the good and failed probe values (e.g., filter out the greatest and lowest 25% of values). The probe platform 122 then calculates an average (e.g., median, mean, weighted mean or other average) of the remaining good probe values. In one embodiment, a weighted average value can represent the optimal keep-alive timer value. In another embodiment, the probe platform 122 determines a minimum value of the failed or closed probe values. If the average good probe value is shorter than the minimum fail pr closed probe value, the average value represents an optimal keep-alive timer value. Otherwise, the minimum fail or closed probe value multiplied with a safety multiplier can represent the optimal. In yet another embodiment, the optimal keep-alive timer value can be multiplied with a safety multiplier to determine a safe optimal keep-alive timer value.

In an embodiment, the probe platform 122 can determined to extend the re-connection delay value e.g. if the filtered and weighted average of the closed probe data is below a certain threshold. In other embodiment the reconnection delay value is extended if the weighted mean of the closed values is shorter than the optimal keep-alive timer value—indicating the RAN using temporally shortened inactivity time during busy hours.

In another embodiment, the reconnection delay is extended if there exists a significant fraction of the failed probe values indicating the NAT 115 utilizes the said temporally shortened inactivity timer.

In an embodiment, the probe platform 122 can determined to recommend the UE 101 to voluntary disconnect instead of keeping the connection alive e.g. if the filtered and weighted average of the closed probe data is below a certain threshold where the said threshold being shorter time than for the extended reconnection delay threshold. In another embodiment the voluntary disconnect recommendation can be activated if the weighted mean of the closed values is shorter than the optimal keep alive value—indicating the RAN using temporally shortened inactivity time during busy hours.

In another embodiment the reconnection delay is extended if there exists a significant fraction of the failed probe timer values indicating the NAT 115 utilize the said temporally shortened inactivity timer.

The probe platform 122 may determine to recommend the UE to voluntary disconnect instead of keeping the connection alive if the optimal keep-alive value would be impracticable short.

In another embodiment, the probe database 123 has statistical information about the connections from the determined communication network, but insufficient data to determine an optimal keep-alive timer value, dynamically extended reconnection delay or recommendation of voluntary disconnection instead of keeping the connection alive, or a combination thereof. In this embodiment, the probe platform 122 can select and transmit a safe keep-alive timer value, dynamically extended reconnection delay or recommendation of voluntary disconnection instead of keeping the connection alive, or a combination thereof to send the UE 101. The safe keep-alive timer value can be based on information known about the connection provider without specific mappings. In this embodiment, the UE 101 requesting the probe service can be used as a probe to gather information about the connection and keep-alive timer values, which succeed and which fails due the packets to be lost due the connection determined to be closed before the probe packet is sent. In some embodiments, a connection can have sufficient data to determine an optimal keep-alive timer value, dynamically extended reconnection delay or recommendation of voluntary disconnection instead of keeping the connection alive, or a combination thereof at one time, but not have sufficient data at a later time due to a change in the service. The change in service can be reflected in an excessive number of failed or closed probe notifications being received. In one embodiment, the communication networks having a good enough measurement data to determine the optimal keep-alive timer value, dynamically extended reconnection delay or recommendation of voluntary disconnection instead of keeping the connection alive, or a combination thereof are verified by requesting the UE 101 make a measurement for verification purpose if the latest measurement data is not current.

In one embodiment, the probe platform 122 can determine the regulate probe connections from clients. In this embodiment, the probe platform 122 can block or “blacklist” clients with certain identifiers that respond with incorrect or unreliable probe values. In one embodiment, a client can be blacklisted if it consistently responds with probe values that are filtered out. In one embodiment, information the blacklisted clients respond with will not be used for determining optimal keep-alive timer values, dynamically extended reconnection delays or recommendations of voluntary disconnection instead of keeping the connection alive, or a combination thereof.

As shown in FIG. 1, the system 100 comprises a user equipment (UE) 101 having connectivity to the service platform via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), emerging Fourth Generation (4G) cellular networks combining the networks mentioned earlier into a seamless virtual network and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), embedded device like home gateway, burglar alarm system, wireless or wire line sensor network node or gateway, a node in industry automation network, vehicle telemetry device or any combination thereof. It is also contemplated that the UE 101 can support any type of interface to the user (such as “wearable” circuitry, etc.) or providing no user interface either directly or in-directly.

By way of example, the UE 101 and the service platform 120 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

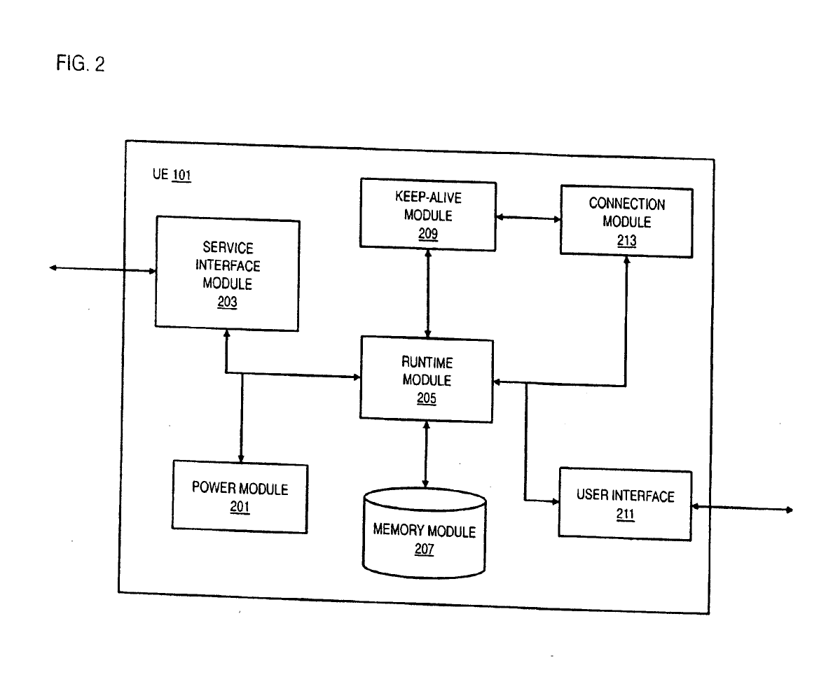

FIG. 2 is a diagram of the components of user equipment 101 of one of the said possible explanatory types that can utilize optimal keep-alive timer values dynamically extended reconnection delays or recommendations of voluntary disconnection instead of keeping the connection alive, or a combination thereof, according to one embodiment. By way of example, the UE 101 includes one or more components for utilizing keep-alive timer values and to be utilized to determine using the delayed re-connection or perform voluntary disconnect instead of keeping the connection alive and synchronized to the said events. It is contemplated that the functions of these components may be combined in one or more components or performed by other components of equivalent functionality. In this embodiment, the UE 101 includes a power module 201, a service interface module 203, a runtime module 205, a memory module 207, a keep-alive module 209, a user interface 211, and a connection module 213.

The power module 201 provides power to the UE 101. The power module 201 can include any type of power source (e.g., battery, plug-in, fuel cell etc.). Additionally, the power module can provide power to the components of the UE 101 including processors, memory, and radio modems.

In one embodiment, the UE 101 includes a user interface 211. The user interface 211 can be used to display information to a user. The user interface 211 can be used to display an application 109 to a user. In one embodiment, the application 109 can utilize a service (e.g., messaging, e-mail, news feeds, etc.) that requires a connection to be continuously live or be virtually connected using disconnection and synchronized delayed re-connection instead of keeping the connection alive if it would require impracticably short keep alive timer value.

In one embodiment, the UE 101 includes a service interface module 203. The service interface module 203 is used by a runtime module 205 to request and receive services from the service platform 120. In one embodiment some services (e.g., instant messaging, e-mail notification, news feeds, etc.) can require a continuous live or virtually continuous connection and in some embodiment provide the maximum message delivery latency which the application tolerates. The application interface module 203 can use multiple communications technologies to communicate with a service platform 120. For example, the application interface module 203 can interface with the service platform 120 using a wireless local area network (WLAN), or a cellular network.

In one embodiment, the UE 101 can include a connection module 213. The runtime module 205 can use the connection module 213 to retrieve data (e.g., data regarding MCC, MNC, internet protocol address, a cellular identifier, gateway, etc.) about a connection device that the UE 101 is connected to. The information can be stored in a memory module 207. In one embodiment, the runtime module 205 relays this information to a probe platform 122 via the service interface module 203. In another embodiment, this information is used to request a keep-alive timer value, possible dynamically extended reconnection delay or recommendation of voluntary disconnection instead of keeping the connection alive, or a combination thereof from the probe platform 122. In other embodiment the service platform 120 determines the information based on the communication network protocol headers like the source internet protocol address seen by the firewall 121 or the probe platform 122 or combination thereof. The probe platform 122 can determine an optimal keep-alive timer value as well as the said reconnection delay or recommendation of voluntary disconnection instead of keeping the connection alive for the UE 101 to use based on the received data from the application 109 in the device 101 or by the said determined data or combination thereof. The probe platform 122 can calculate the keep-alive timer value, possible dynamically extended reconnection delay or make a recommendation of voluntary disconnection instead of keeping the connection alive, or a combination thereof using information from other UEs 101 utilizing services associated with the probe platform 122. In this embodiment, the runtime module 205 receives the keep-alive timer value, possible dynamically extended reconnection delay or recommendation of voluntary disconnection instead of keeping the connection alive, or a combination thereof and sets the said parameters values in a keep-alive module 209. The UE 101 uses the keep-alive timer value, possible dynamically extended reconnection delay or recommendation of voluntary disconnection instead of keeping the connection alive until the user leaves the network or another event occurs like the validity time associated by the probe platform 122 to the values expires causing the UE 101 to request a new keep-alive timer value as well as the said other parameters.

In one embodiment, the probe platform 122 can request the UE 101 to act as a probe to gather information about the characteristics of the connection. In one embodiment, the UE 101 performs a probing session requested by the probe platform 122. In this embodiment, the UE 101 requests a keep-alive timer value, reconnection delay and recommendation of voluntary disconnection instead of keeping the connection alive from the probe platform 122. The probe platform 122 returns a response including a request for the UE 101 to act as a probe and indicating a timer value. In one embodiment, this value is a probe period value to be used by the module 209 to gather information. In this embodiment, the keep-alive module 209 can set a keep-alive timer value as instructed by the probe platform 122. The keep-alive module 209 can then wait a period corresponding to the keep-alive timer value and then send another request for an updated keep-alive timer value. The probe platform 122 can respond so that the keep alive module can get determine the probe to be successful and increase the probe timer period. The runtime module 205 updates the keep-alive module 209 timer value. In one embodiment, the keep-alive module 209 waits the period and attempts another request for an updated keep-alive timer value. In this embodiment, the connection has been dropped by one of the RAN 111, devices 113, 115 or 117 on the route. The runtime module 205 sets up a new connection and sends another request for an updated keep-alive timer value while reporting the connection failure. In another embodiment the keep-alive module 209 stores the failed probe period to be informed to the probe platform later on. The probe platform 122 or the runtime module 205 then decreases the keep-alive timer value period. The process is followed until the maximum successful keep-alive time value and minimum failed one are found and it is not needed to update the keep-alive timer probe period any longer.

In some embodiments, the keep-alive module 209 may determine the connection to be closed during the wait period before the keep-alive probe period has expired. The runtime module 205 may set up a new connection and sends another request reporting the connection closure. In another embodiment the keep-alive module 209 stores the elapsed period before the determination of the connection closure after the successful probe to be informed to the probe platform later on.

The determination can be from a set number of probing iterations (e.g., 10 iterations), or after a standard is met (e.g., a good timeout period determined following a decrease in keep-alive timer value because of a failed keep-alive timer value) or if the keep-alive module has detected a number of connection closures. The runtime module 205 can transmit information about the good keep-alive timer values and failed keep-alive timer values and determined time periods between the connection closures and previous success full probe back to the probe platform 122, which may store the values in a probe database 123.

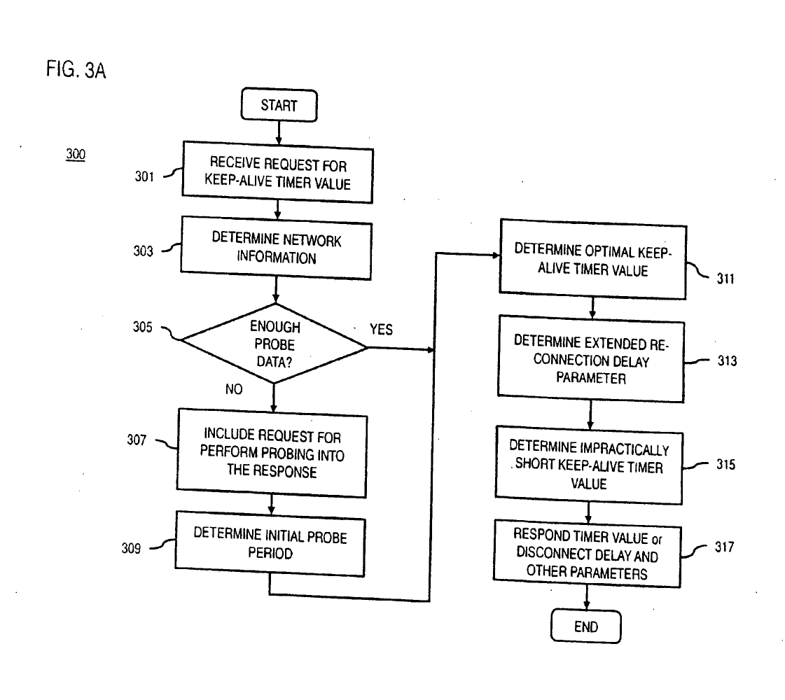

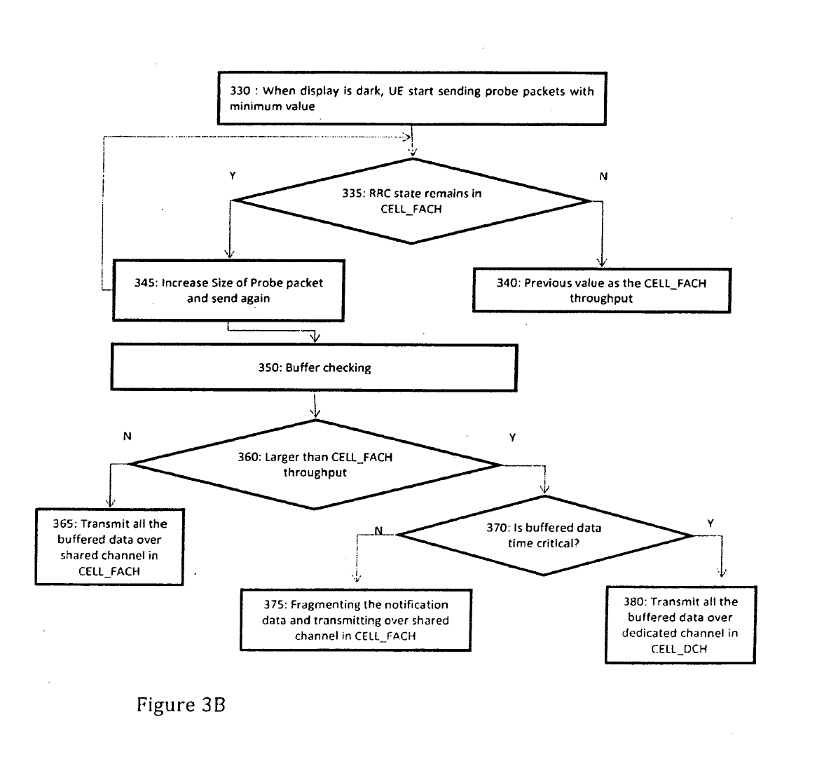

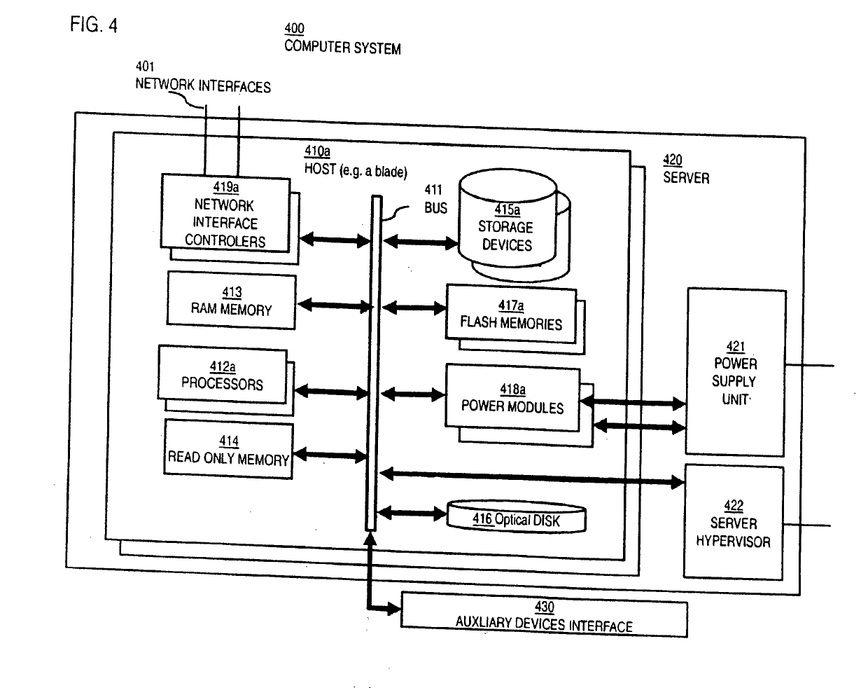

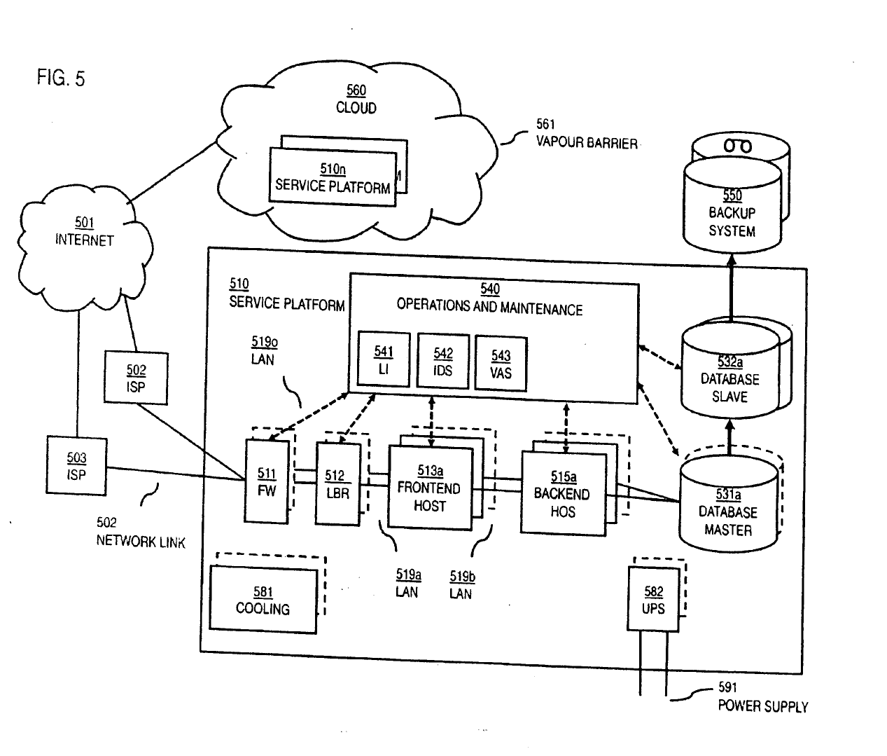

FIG. 3a is a flowchart of a process for obtaining optimal keep-alive timer values by the probe platform 122, according to one embodiment. In one embodiment, a probe platform 122 performs the process 300 and is implemented in, for instance, in host 410a of FIG. 4 acting as host 513a, 515a or combination thereof in the service platform 120 as shown in FIG. 1 and service platform 510 of FIG. 5.

In step 301, the probe platform 122 receives a request from a UE 101 for a keep-alive timer value, possible dynamically extended reconnection delay or recommendation of voluntary disconnection instead of keeping the connection alive, or a combination thereof. In one embodiment, the UE 101 initiates the request when served by a communication network such as a cellular, WiMAX, LTE, 4G or satellite network, but not when connected via Wifi or wire line access network.

At step 303, the probe platform 122 determines network information associated with the request. In one embodiment, the request specifies network information related to a network serving the user equipment, home burglar alarm device, embedded vehicle telemetry system a-like. In one embodiment, network information includes information used to identify a connection (e.g., a MCC, a MNC, an internet protocol source address, a cellular identifier, a gateway, etc).

At step 305, the probe platform 122 determines if there is adequate probe data to determine the optimal keep-alive timer value. In one embodiment, there is adequate probe data if there has been at least a set number of probing sessions for the connection identified by the network information. In this embodiment, the set number can be a configuration parameter set in a probe database 123. In one embodiment, each UE 101 that requests probe information is asked to complete a probe session until adequate probe data is obtained. The probe platform may include the request for performing probing into the response containing the optimal keep-alive timer value and the other said parameters.

At step 307, if there is not inadequate probe data for the particular network using narrow criteria like the internet protocol source sub network address; the probe platform 122 may determine the keep-alive timer value using wider criteria like MCC/MNC values determined at step 303. If there is not enough probe data using the wider criteria, the probe platform may determine to return a safe default value for the keep-alive time to be used by the applications (e.g. messaging) as a temporary value before the optimal value is found and requests the UE 101 to perform a measurement. In this embodiment, the UE 101 will perform a probing session. In one embodiment the probe platform may determine to include an indication of the absence of the narrow criteria data into the response to be sent at step 317. Still in this embodiment the indication is a confidentiality level metric having low value.

At step 309, the probe platform 122 determines the initial probe period associated via wider criteria to the network information determined at step 303. In one embodiment, the probe platform 122 can request the probing to start with a default period if the probe database does not contain enough data associated to the said wider information criteria. In this embodiment, the probing session can yield data about successful keep-alive timer probe values and unsuccessful keep-alive timer probe values due lost packets or connection closures during the wait period.

In one embodiment, the values are stored in a probe database 123. In another embodiment, the probe platform 122 initiates transmission to inform the UE 101 of a keep-alive timer value based on this information. In yet another embodiment, the probe platform 122 determines an optimal keep-alive timer value for the UE 101.

At step 311, the probe platform 122 determines the optimal keep-alive timer value, possible dynamically extended reconnection delay or recommendation of voluntary disconnection instead of keeping the connection alive, or a combination thereof based on the communication network information. In one embodiment, the probe platform 122 parses the network information to map gateways based on a wider criteria like MCC, MNC, or cell identifiers of the RAN 111. In other embodiment the probe platform determines the optimal keep-alive timer value, possible dynamically extended reconnection delay or recommendation of voluntary disconnection instead of keeping the connection alive, or a combination thereof via narrow criteria associated to the network information determined in step 303 like the internet protocol source address. In another embodiment, the probe platform 122 determines network information based on global positioning system (GPS) coordinates or other satellite or terrestrial geolocation systems including but not limited to Galileo, Glonass, and determination of recorded WLAN MAC addresses or combination thereof. In this embodiment, the probe platform 122 can track networks associated with certain GPS coordinates and store the associated GPS (or said other location systems) coordinates in a probe database 123. In other embodiments, the network information can be used to map the UE 101 to a network. In one embodiment, the probe platform 122 associates the UE 101 with a particular gateway (e.g. GGSN) 113. The probe platform 122 then determines an optimal keep-alive timer value associated with that gateway or other network information mapping.

In one embodiment the optimal keep-alive time value may have been obtained from the communication network operator having control to all devices 111, 113, 115 and 117 from the UE 101 to the internet 103. When it is not possible to obtain the optimal keep-alive value in that way, it may be determined statistically utilizing the keep-alive probe timer values measured by the other keep-alive modules 209 in other UEs 101.

The probe platform 122 may query a probe database 123 for successful and unsuccessful probe values. Successful probe values and unsuccessful probe values can be received from a plurality of UEs 101 that are associated with the network information mapping and stored in the probe database 123. The unsuccessful probe values may contain values indicating the connection closures. In one embodiment, the plurality of UEs 101 can have common network information. In one embodiment, the probe platform 122 utilizes only these probe values.

The probe platform may determine the optimal keep-alive value calculation an average of the probe values associated to the network information via a narrow or wider criteria or a combination thereof. The probe platform may calculate a weighted average to determine the optimal keep-alive value statistically. In one embodiment a weighted average of successful probe values associated with the network information is calculated. The average could be a median, a mean, or other statistical model. In one embodiment, this average successful value is an optimal keep-alive timer value. In another embodiment, more calculations are involved in the determination.

In another embodiment, the probe platform 122 determines a minimum unsuccessful value of the unsuccessful probe values due lost probe packets, determined closures of the connection, or combination thereof. The unsuccessful probe values represent a maximum keep-alive timer value that had become disconnected. The minimum unsuccessful value represents a keep-alive timer value close to an optimal value. In one embodiment, the minimum unsuccessful value is determined from values that have been filtered to eliminate outlier values. In one embodiment, the optimal keep-alive timer value is a statistical determination (e.g., an average, a weighted average, etc.) of the average successful value is lower than the minimum unsuccessful value. In another embodiment, the optimal keep-alive timer value is the minimum unsuccessful value modified by a safety parameter. In one embodiment the unsuccessful value may be due the keep-alive module 209 has determined a connection closure. The safety parameter can be, for example, a value that the minimum unsuccessful value is multiplied by to determine a safe value, as the minimum unsuccessful value may not be safe because it is known to fail. In another embodiment, the safety parameter can be a weighted average of the average successful value and the minimum unsuccessful value. At step 317, the probe platform 122 respond the optimal keep-alive timer value based on its determination. In one embodiment the probe platform 122 may determine to include a confidentiality level metrics of the optimal keep-alive time into the response. The confidentiality level may be determined based on the utilized narrow or wider criteria, the amount of the probe data in the database 123, the variance of the data selected using the narrow or wider criteria, the statistical distance of the good probe values to the failed or closed ones, or a combination thereof.

At step 313 the probe platform 122 may include a reconnection delay parameter into the response to be sent at step 317. In another embodiment the said parameter is included only if the optimal keep alive value is below a threshold value. Yet in another embodiment the probe platform 122 may determine to extend the re-connection delay dynamically based on the determined and reported connection closures, variance of the reported probe value associated via the narrow or wider network criteria, or a combination thereof. The probe platform may include the said information to the response to be sent at step 317.

At step 315, probe platform 122 determines if the optimal keep-alive value determined at step 305 is suspected to be too short to be unpractical. The keep-alive value determined at step 309 may be determined as impractical if it's shorter than a threshold. The probe platform may determine to send a recommendation and criteria for voluntary disconnection information to UE 101 at step 317.

At step 315, probe platform 122 determines if the optimal keep-alive value determined at step 305 is suspected to be too short to be unpractical for the UE 101. In one embodiment the keep-alive value determined at step 309 may be determined as impractical if it is determined to be shorter than a threshold. In another embodiment the said value may be determined to be impractical if the database 123 contains probe values indicating connection closures after a wait period shorter than the determined optimal keep-alive value at step 311. In another embodiment the said value is impractical if the database 123 contains probe values indicating connection closures after a wait period shorter than the determined optimal keep-alive value at step 311. In another embodiment the probe platform may determine the impracticality by calculating statistical characteristics of the good and failed probe values or combination thereof including by not limited to statistical variance. The probe platform 122 may determine to send a recommendation and criteria for voluntary disconnection information to UE 101 at step 317.

As stated above, a problem exists in that resources can be required just to maintain a fully connected state between a device, such as user equipment (UE), and a network. Further, power consumption is one key performance indication of a device. This is especially true for a device such as a smart phone which usually has many applications running simultaneously.

In a High-Speed Downlink Packet Access (HSDPA) network for small packets transmission usually a device is set to a CELL_FACH state. In the HSDPA network a UE uses a random access channel (RACH) for UL packet data transmission and a forward access channel (FACH) for DL data transmission. However, this is not seen to be efficient for at least the reason that there is no power control on either of these communication channels. In addition, the RACH (random access channel) and FACH (forward access channel) are not designed to support a high number of UE devices. To address these issues enhanced CELL_FACH (cell forward access channel) has been accepted by the 3GPP standards body (e.g., 3GPP Rel-7) for use in HSPA networks, as well as other networks. Data packets can now be transmitted over a High-speed Downlink Shared Channel (HS-DSCH) which increases the available data rate in CELL_FACH. Furthermore, there is an option of transmitting data to users in CELL_PCH (cell paging channel) or URA_PCH (UTRAN registration area paging channel) which provides an effective means of supporting background traffic, such as for presence updates and/or broadcast news to always connected UEs. UTRAN referred to by 3GPP as a Universal Terrestrial Radio Access Network.

From a UE point of view, for example, one obvious advantage of transmitting data over CELL_FACH is current consumption. Based on measurement results, it is shown that current consumption can be reduced significantly (e.g., on the level of approximately 40%) compared to a dedicated channel in CELL_DCH (cell dedicated channel) state.

However, the configuration of CELL_FACH such as for data throughput etc. can be different between operators and/or infrastructure vendors. Moreover in most cases application developers do not concern themselves regarding performance issues or, in a worst case, they are not aware of any current consumption issues. For at least this reason there appears to be a lack of understanding regarding power-efficient schemes, such as provided by 3GPP, by the application developers. Thus, there can be seen to be a need to address these issues in such a way that does not require application developer's additional involvement, for example.

In accordance with an exemplary embodiment of the invention there is at least a method performed by an apparatus to enable improved usage of data transmission scheme when a UE, such as a mobile device, is in CELL_FACH or CELL_PCH states. An adaptive transmission scheme is proposed for short length data packets, such as keep-alive and presence updates etc. In accordance with the embodiments, the method enables the apparatus to efficiently use the CELL_FACH and/or CELL_PCH state based on an available throughput in such states. In this way, in accordance with the embodiments, the transactions made to CELL_DCH channels can be reduced and UE power consumption can be reduced as well.

A method in accordance with the exemplary embodiments of the invention is described below for the benefit of a UE, or terminal side device, and a network server.

### UE/Terminal Side Device

(1) If not broadcasted by the network, a UE can probe the maximum data packet size (example values like 256 bytes) for an UE to be stayed in CELL_FACH/CELL_PCH/URA_PCH state. This can be easily implemented by transmitting multiple packets with different typical sizes (e.g. 128 bytes, 256 bytes, 512 bytes etc.) and monitor the RRC state change.
(2) UE will report the results to a server if the server does not have the information. The server will keep the information in one place e.g. database and the information will be used by the server to specify the notification message.
(3) For a certain area, it is also possible that the server already have the information about the maximum throughput on CELL_FACH. Once the server has gotten the information, there is no need for the UEs to do this.
(4) If there is data in the UE buffer for transmission, UE determines whether to transition to/from CELL_DCH or CELL_FACH based on the amount of data in the buffer. In accordance with the embodiments, short messages like ACK/NACK can be delivered over shared channel in CELL_FACH state.
(5) If the display is off and the timing requirements for the data packets is not high, the data packets can be sent later or sent in smaller packets, such as based on available throughput of CELL_FACH channels. This leads to less power consumption.

### Server

(1) Server will collect peak throughput information when UEs are in CELL_FACH/CELL_PCH/URA_PCH state.
(2) If the display is OFF, Nokia server can split the NRT notifications into couple of small packets and transmitted over CELL-FACH state instead of CELL_DCH status.
(3) When the display is switched from OFF to ON state, update all the background traffics including IM, status update etc. Although this will bring a big data traffic, user experience is much better.

FIG. 3B a flowchart of a process for an adaptive data transmission scheme in accordance with the exemplary embodiments of the invention. As illustrated in FIG. 3B, at step 330 when the display of a UE is dark, such as in a standby mode, the UE will start sending probe packets with a minimum value. At step 335, it is determined whether a radio resource control (RRC) state of the UE remains in a CELL_FACH. If it is determined at step 335 that the RRC state of the UE does not remain in the CELL_FACH then at step 340 a previous value is used as the CELL_FACH throughput. If it is determined at step 335 that the RRC state of the UE does remain in the CELL_FACH then at step 345 a size of probe packets is increased and the probe packets are again sent. In step 350 there is buffer checking. At step 360 it is determined whether a size of the buffer is larger than the CELL_FACH throughput. If it is determined that the buffer size is not larger than the CELL_FACH throughput then at step 365 all buffered data is transmitted over a shared channel in CELL_FACH. If it is determined that the buffer size is larger than the CELL_FACH throughput then at step 370 a further determination is made as to whether the buffered data is time critical. If at step 370 it is determined that the buffered data is not time critical then at step 375 there is fragmenting the notification data and transmitting over a shared channel in CELL_FACH. If at step 370 it is determined that the buffered data is time critical then at step 380 there is transmitting all the buffered data over a dedicated channel in CELL_DCH.

With the approaches as described herein, a UE 101 can use services from a service platform 120 of FIG. 1 or 510a-n of FIG. 5 that require a continuous live or virtually continuous connection with optimal keep-alive parameters, extended re-connection delay and voluntary disconnection recommendations determined by a probe platform 122. In one embodiment the service platform 510a may contain only the probe platform 122 while e.g. the email or IM services are provided by other service platform 511b or from a cloud 510. In other embodiment the probe platform coexists in the same service platform 510 or in cloud 560. In one embodiment the probe platform 122 listens to the same Transport Control Protocol (TCP) port number into which the application 109n is connected. Because the optimal keep-alive parameter is determined by the probe platform 122, each UE 101 does not have to separately attempt to discover the keep-alive timer value or determine the possible connection closures. In this manner, the UE 101 can rely on data gathered by other UEs 101. Because the probe platform 122 implemented as a host 410 in 513a or 515a in FIG. 5 determines the keep-alive parameter, extended re-connection timer and recommendation for voluntary disconnect instead of keeping the connection alive based on network information associated with the UE 101 and other UEs 101, the keep-alive timer value and the said other parameters is tailored to the UE 101 served by the specific communication network. The optimal keep-alive parameter keeps the UE 101 connected to the network with fewer unnecessary keep-alive transmissions, thereby saving battery life. The extended re-connection delay saves battery and the RAN 111 signaling load by delaying the re-connection in those networks suffering for connection closures e.g. due RAN 111 or NAT 115 congestion. The voluntary disconnection suggestion avoids keeping alive connections requiring impractically short period.

In one embodiment the applications 109n determines the allowed latency for the message delivery and if that being long enough compared to the re-connection delay and voluntary disconnection criteria provided by the probe platform 122, the application 109 determines to disconnect voluntary. In one embodiment the application 109 re-connects after the delay. In other embodiment all applications 109b-109n re-connect effectively at the same time. Still in another embodiment some applications determine not to re-connect at all suggested reconnection times.

The processes for the probe platform 122 and UE 101 described herein for providing an optimal keep-alive timer value, extended re-connection delay and recommendation for voluntary disconnection instead of keeping the connection alive may be advantageously implemented via software, hardware (e.g., general purpose microprocessor, firmware or a combination thereof. Such exemplary hardware for performing the described functions is detailed below.

FIG. 4 illustrates a computer system 400 upon which an embodiment of the invention may be implemented. Computer system 400 contains one or more hosts 410a-410n in a server 420. Each one of the hosts 410a-n is programmed (e.g., via computer program code or instructions) to provide and determine a keep-alive timer value as described herein and includes a communication mechanism such as a bus 411 for passing information between other internal and external components of the host 410. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 411 includes one or more parallel conductors of information so that information is transferred quickly among devices coupled to the bus 411. One or more processors 412 for processing information are coupled with the bus 411. In some embodiments the host 410 contains multiple busses between the different internal and external devices. Some of the said busses are internal to the processor 412, and some are internal to the host 410 while some are extended to the server 420 or to the auxiliary devices 430.

Processors 412a-n performs a set of operations on information as specified by computer program code related to providing an optimal keep-alive timer value, delayed reconnection time, voluntary disconnection recommendation, or combination thereof. The computer program code is a set of instructions or statements providing instructions for the operation of the processor 412, host 410, server 420 and/or the computer system 400 to perform specified functions. The code, for example, may be written in a computer programming language that is compiled into a native instruction set of the processor. The code may also be written directly using the native instruction set (e.g., machine language). The set of operations include bringing information in from the bus 411 and placing information on the bus 411. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 412, such as a sequence of operation codes, constitute processor instructions, also called computer system instructions or, simply, computer instructions. Processors may be implemented as mechanical, electrical, magnetic, optical, chemical, and/or quantum components, among others, alone or in combination.

A host 410 in the computer system 400 also includes a memory 413 coupled to bus 411. The memory 413, such as a random access memory (RAM) or other dynamic storage device, stores information including processor instructions for providing an optimal keep-alive timer value. Dynamic memory allows information stored therein to be changed by the host 410 in the computer system 400. RAM allows a unit of information stored at a location called a memory address to be stored and retrieved independently of information at neighboring addresses. The memory 413 is also used by the processor 412 to store temporary values during execution of processor instructions. The host 410 in the computer system 400 also includes a read only memory (ROM) 414 or other static storage device like an optical disc 416 or flash memory 417 coupled to the bus 411 for storing static information, including instructions, that is not changed by the host 410 of the computer system 400. Some memory is composed of volatile storage that loses the information stored thereon when power is lost. Also coupled to bus 411 are non-volatile (persistent) storage devices, such as a magnetic disk 415, optical disk 416 or flash memory 417, for storing information, including instructions that persists even when the computer system 400 is turned off or otherwise loses power.

Information, including instructions for providing the optimal keep-alive timer value and the said other parameters, is provided to the bus 411 for use by the processor from non-volatile memory device 414, 416, 417, 418 from external device 430 like an USB memory module, or loaded from the network interface 419 from the O&M module 540 in FIG. 5, by the server hypervisor 422 or combination thereof. In one embodiment the external devices 430 contains human interface devices like keyboard, display, mouse, touch pad.

Hosts 410a-n in the computer system 400 also includes one or more instances of a communication interfaces like the network interfaces 419 or interface to the auxiliary devices 430 coupled to bus 411. Said communication interfaces provides a one-way or two-way communication coupling to a variety of external devices that operate with their own processors, such as printers, scanners and external disks, hypervisor 422, the other hosts, servers, computer systems, databases in the service platform 120 shown FIG. 1 or service platforms 510a-n and devices 511, databases 531a-n shown in FIG. 5 as well to the Operations and Maintenance system (O&M), In general the coupling is with a network interfaces 401 that is connected to a server 420 backend and to the local network 519a,b,o shown in FIG. 5 to which a variety of external devices with their own processors are connected. For example, communication interface 430 may be a universal serial bus (USB), port commonly used also in personal computers. In some embodiments, communications interface 401 is may be implemented by a local area network (LAN) interface controller to provide a data communication connection to a compatible LAN, such as Ethernet. In other embodiment the NIC 419 is a fiber interface card. In certain embodiments, the communications interface 401 enables connection to the communication network 105 for providing an optimal keep-alive timer value, delayed re-connection delay, recommendation of voluntary disconnection or combination thereof to the UE 101.

The term computer-readable medium is used herein to refer to any medium that participates in providing information to processor 412, including instructions for execution. Such a medium may take many forms, including, but not limited to, non-volatile media, volatile media and transmission media. Non-volatile media include, for example, optical 416 or magnetic disks, such as storage device 415. Volatile media include, for example, dynamic memory 413. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media. In some embodiment the instruction code determining the optimal keep-alive timer value and the other parameters is transmitted to the volatile flash memory 417, storage devices 415 or non-volatile memory 413 of the host 410 via the communication interface 401, 430 or 422, or combination thereof. In some embodiment the instructions are transmitted from the computer system hypervisor 422. Yet in other embodiment the instructions are transmitted from another host of the service platform shown in FIG. 5. In one embodiment the instructions transmitted over the interface 401 or 422 from the O&M 540 shown in FIG. 5.

FIG. 5 illustrates a service platform 510 upon which an embodiment of the invention may be implemented. One or more of the hosts 513a-n, 515a-n or combination of the thereof is programmed to provide an optimal keep-alive timer value, extended reconnection delay, recommendation for voluntary disconnection if the determined keep-alive period is impractically short as described herein and includes, for instance, the front and back end hosts described with respect to FIG. 4 incorporated in one or more physical servers and computer systems. The service platform 501 is connected to the internet via one or more internet service providers 502, 503. In most of the embodiments the service platform contains one or more edge firewall 510. In particular embodiment the firewall 510 is configured to have substantially longer inactivity timeout than the firewalls 117 in FIG. 1. In other embodiment the probe platform 122 is implemented in one or more front end hosts 513. In other embodiment the probe platform is implemented in one or more back end hosts 515. In some embodiment the probe platform may be implemented a combination of these two, load balancer 511, firewall 510 or third layer hosts (not shown).

In some embodiment the probe platform 122 is aware of the timeout configuration of the firewall 511, load balancer 512 or combination thereof. In other embodiment the firewall 511 and load balancer 512 are configured to have their inactivity timeouts equal or longer than what the probe platform 122 implemented by hosts 513, 515 or combination thereof, will use as the longest optimal keep-alive value. In certain embodiment the said timeout is equal or longer to 1 hour.

The service platform 510 may contain also databases 531 and 532. In many embodiments the databases are duplicated for error resiliency. On some embodiments the duplicated databases are arranged into master slave relationship. In certain embodiment the databases 513, 515 or combination thereof are implementing the probe database 123 shown in FIG. 1. The database content may be replicated periodically into a special separate backup system 550 containing magnetic, optical disc, solid state (FLASH EEPROM) discs, high capacity magnetic tape archive systems or combination thereof.

The service platform may contain an Operation and Maintenance system 540 including, but not limited to Lawful Interception (LI) 541, Intrusion Detection System 542 and Vulnerability Assessment System. In one embodiment the data stored into the probe database 123 as implemented by master 513, slave database 515 or combination thereof, is utilized by the O&M's LI 541 and IDS 542.

In some embodiment the instruction code determining the optimal keep-alive timer value, extended delayed keep-alive delay, voluntary disconnection recommendation or combination thereof is transmitted to the host 410 implementing the probe platform 122 in the hosts 513 or 515 or combination thereof, is transmitted from the O&M 540 system. In one embodiment the O&M system is implemented with one or more computer systems 400 of FIG. 4.

The power supply and cooling systems are included in FIG. 4 for completeness. They as well as the O&M system 540 and backup system 550, as illustrated in FIG. 5, may be shared by multiple service platforms 510. A service platform 510 may implement just the probe platform 123. In other embodiment the service platform 510 implements also some other services in addition to the probe platform 123. The service platform 510 or combination of multiple instances of them may be shared by multiple services. In one embodiment the sharing is implemented with virtualization of the computer systems 400. In other embodiment the sharing is implemented by virtualization of the service platforms 510a-n. In some other embodiments the service platforms comprising the virtualized service platform 500 are geographically dislocated. In certain embodiment the said virtual collection of service platforms 510a-n is called a Cloud 560. Still in other embodiment the probe platform 123 providing the optimal keep-alive timer value, extended re-connection delay, recommendation of voluntary disconnection in the case the optimal keep-alive timer value is determined to be impractically short is implemented in the said virtually combined, optionally geographically dislocated service platform 510.

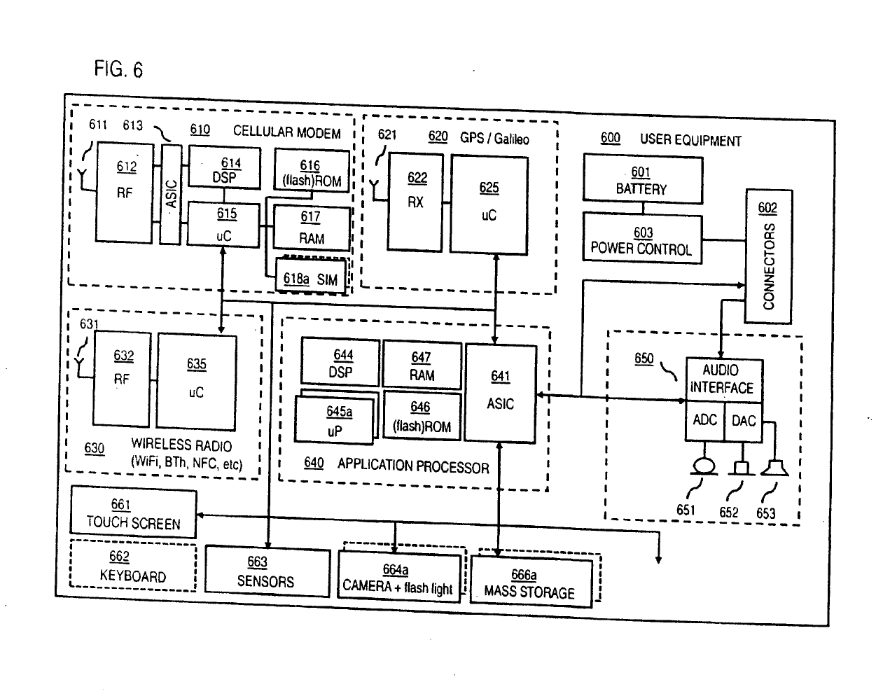

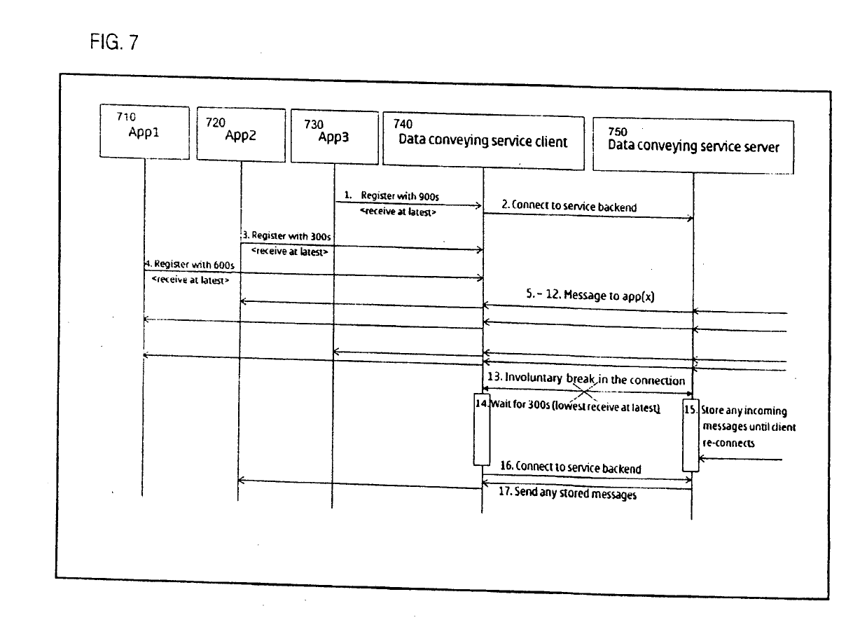

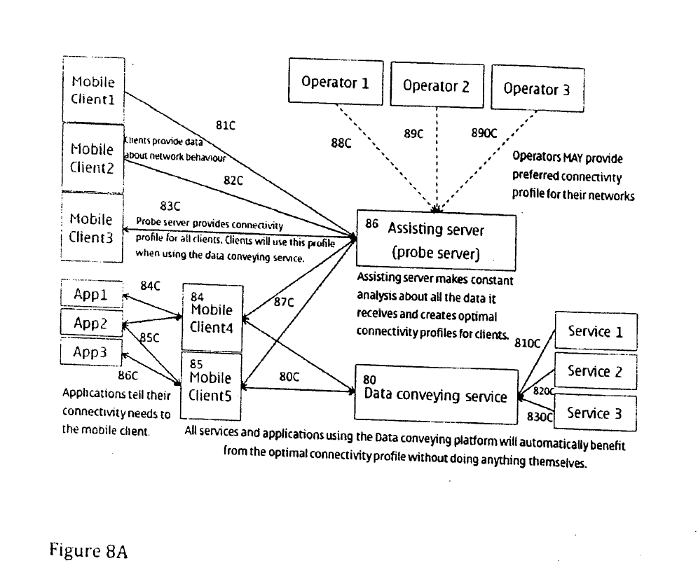

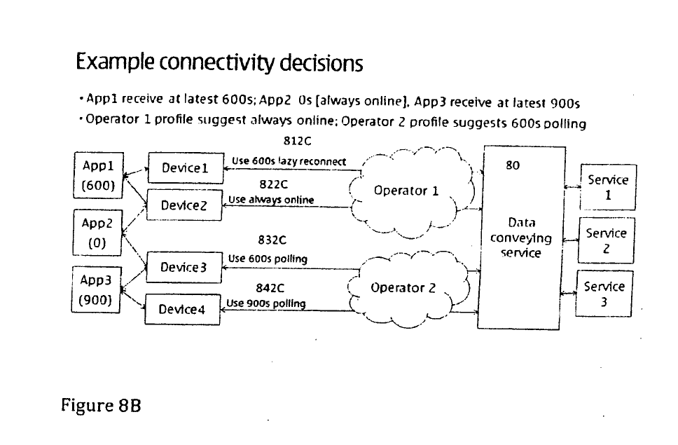

FIG. 6 is a diagram of exemplary components of user equipment (e.g., a smart phone) capable of operating in the system of FIG. 1, according to one embodiment. In other embodiments the sample user equipment performs the operations described in FIG. 7, or FIG. 8A or FIG. 8B, as non-limiting examples. Generally, the user equipment contains one or more interconnected microprocessor powered subsystems. In various common embodiments some of the said subsystem contains a radio receiver to communicate over a cellular, Wireless Local Area Network (WLAN, WiFi), Personal Area Network (PAN) like BlueTooth, Near Field Communication (NFC) and other possible and yet to be developed communication networks or combination thereof. The said subsystems comprising a radio transceiver is often defined in terms of front-end and back-end characteristics. The front-end of the transceiver encompasses all of the Radio Frequency (RF) circuitry whereas the back-end encompasses all of the base-band processing circuitry. Pertinent internal components of the transceiver subsystem may include micro controllers (uC) 615, 625, 635, a Digital Signal Processor (DSP) 614, and a receiver/transmitter unit 612, 622, 632 including a microphone gain control unit and a speaker gain control unit. Some of the uC powered subsystems e.g. (620) may contain only radio received e.g. for GPS or FM-radio (not shown) while some (610, 630) contains also transmitter.

In one embodiment, the long distance radio modem 610 uses a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wideband code division multiple access (WCDMA), 4G, satellite, and the like.

An optionally incorporated SIM card 618 carries, for instance, important information, such as the International Mobile Station Identity, the carrier supplying service, subscription details, and security algorithms and keys. The SIM card 618 serves primarily to identify the long distance transceiver subsystem mobile station 610 on a radio network. The card 615 may also contain a memory for storing a personal telephone number registry, text messages, and user specific mobile station settings.

Many of the subsystems illustrated as a single block in FIG. 5 are internally uC powered like the cameras 664a-b. The subsystems may be built using one or more integrated circuits (IC), a set of the said circuits designed to work together are often called a chipset. In one embodiment a chipset may provide just the functionality of a certain uC powered subsystem like the GPS received 620. In other embodiment the same chip set contains the functionality of multiple functional uC powered subsystems as shown as illustrated by the short ranged radio sub module 630 comprising WLAN, BlueTooth, Wireless Sensor Network (WSN) and NFC radio transceivers.

The heart of the user equipment 600 is the application processing subsystem containing one or more microprocessors 645a-n, RAM and ROM memories 646, 647, DSP 644, ASIC 641, Graphics Processing Unit (GPU, not shown) or combination thereof. In an embodiment the ASIC 641 contains GPU functionality. The application processor 645a-n may read the instructions from the non-volatile memory 646 into RAM 645 to be executed according to FIG. 3A to determine the optimal keep-alive time, determine to utilize the extended delayed re-connection delay or voluntary disconnect if the optimal keep-alive timer value is determined to be impractically short according to the parameters provided by the probe platform 122.

In one embodiment the application processing unit 640 is a physically separate subsystem. In other embodiment the micro controller 615 of the cellular modem 610 acts as the application processor and the instructions are loaded from ROM 616 into RAM 617 to perform the said determination of the optimal keep-alive timer, extended delayed re-connection delay and voluntary disconnection.

Still in other embodiment the cellular modem 610 and the application processor are implemented in different physical devices and interconnected for example over a pair of short range radio transceivers 630.

The user equipment may contain one or more displays. Together with the display there may be keyboards, buttons, touch pads, voice and image detections systems, ambience infrared and human visible light detectors, magnetometer, temperature, accelerometer and other sensors, a mean to generate physical movement to the device including, but not limited to a vibration motor or one or more mass actuators, or combination thereof to provide a Human Interface to the user. In certain embodiment a touch screen combining a display and transparent touch pad is the main Human Interface Devices (HID) of the user equipment 600. In one embodiment the human interface is built into the single physical device as the application processor 604. In other embodiment the HID subsystem or part of it is split into different physical devices interconnected e.g. using a one or more short range radio transceiver 630s, infrared light, magnetic field, a cable or a combination thereof. The user equipment may also contain one or more cameras which can be used e.g. for the face detection for the human interface purpose.

The user equipment may also contain audio circuits 650, microphone 651, earpiece 652, one or more loud speaker 653 as well as circuits to drive external head phones or audio HID devices connected over a short range radio transceiver 630. In other embodiments the audio circuits are part of the cellular modem 610. The user equipment may provide connectors also for other accessories like to be connected to a Personal Computer over a USB or firewire (IEEE 1394) interface, to an external mass storage over eSATA, to external video display (not shown) over composite, component or digital video interface like High Definition Multimedia Interface (HDMI), or combination thereof. The user equipment may have one or more non-volatile mass storages 666a-n, one or more connectors for an external mass storage e.g. a flash card or module, eSATA. In another embodiment the external mass storage is physically separate device connected over the short range radio 630. In certain embodiment the mass storage is located into the geographically dislocated virtual service platform in the cloud 560. In a particular embodiment the optimal keep-alive period provided by the probe platform 122 is used to extend the operation time of the UE 101 when the as UE 600 in FIG. 6 is connected to the said external mass storage in the cloud 560.

In addition, it is noted that, typically, mobile services use either always online connection or a polling connection. This invention helps to choose dynamically which of the two (or a hybrid of these two approaches) is most advantageous in the current network conditions with the current set of applications.

At least a method in accordance with the exemplary embodiments of the invention, allows data receiving applications and/or users of these applications to device how time critical the data they may receive is. Based on this information the data conveying service (e.g. a Notification Solution), that typically requires an always online connection, can choose not to re-create the always online connection immediately after losing the connection [due to e.g. signal loss], but instead can wait based on time criticality provided by applications/users until re-connecting. This re-connection will be kept open until the connection is no longer needed—or is terminated for some reason. This behavior creates essentially a hybrid between always online and synchronized polling. In some cases when there is no application requiring fast data reception the client disconnect for a period of time e.g. based on the local activity like display lights, accelerometer, local time (during nights). During the disconnect period it may perform polling with suitably low frequency (e.g. 1/hour) and later re-connect again and keep the connection alive until a next involuntary disconnection occurs.

The exemplary embodiments of the invention provide at least a method including:

1. A client provides an application programming interface (API) for applications to tell their data urgency needs [e.g., <receive at latest> parameter].
2. Based on the given <receive at latest> parameters the client will not reconnect to a cellular network directly after an involuntary disconnection—it will wait for the duration of lowest active <receive at latest> before re-connection. If, however, any of the applications requests a true always online connection the re-connection happens without any wait.
3. Applications also inform the client when they are going to send any data. The incoming notifications of all other applications are read if a single application needs to send any data to its peer service—and for opening the underlying network connection.
4. Client may use local inactivity information including, but not limited to display lights, key presses, accelerometer or local time and alarm clock.

Based on at least these novel feature, it can be seen the exemplary embodiments provide at least:

More reliable connections in poor cellular networks;

Less power consumption in situations when there is no need for the low incoming notification delivery latency and when the cellular RAN requires high keep-alive frequency; and

Less data consumption and signaling load for operator networks—especially in poor network conditions or during typical rush times to minimize risk of the access network is congestion, which may be a very valuable asset for co-operation with the cellular remote access network (RAN) operators; Many current smartphones or even single applications or middleware components behave very badly from the cellular operator points of view.

FIG. 7 illustrates a basic flow of determining a re-connect timer, such as a lazy reconnect timer, in accordance with the exemplary embodiments of the invention. As illustrated in FIG. 7, APP1 at block 710, APP2 at block 720, and APP3 at block 730 and/or a user of these data receiving applications registers in flows 1, 3, and 4, respectively, with the data conveying service client 740 their time critical values (at latest times) regarding receiving data as 900 seconds, 300 seconds, and 600 seconds, respectively.

As indicated in flow 2, the data conveying service client 740 connects to the data conveying service server 750. Flows 5-12 indicate the messages and/or data to the APP1 at block 710, APP2 at block 720, and/or APP3 at block 730. In flow 13 there is an involuntary disconnect between the data conveying service client 740 and the data conveying service server 750. At flow 14, in response to the involuntary disconnect, the data conveying service client 740 waits a period of time before attempting a reconnect, as a non-limiting example 300 seconds, which is the lowest receive at latest value received by the data conveying service client from the APPs (i.e. APP2 value is the lowest in this case. At flow 15 it is shown that the data conveying service server 750 stores any incoming messages/data until the data conveying service client 740 reconnects. At flow 16 the data conveying service client 740 reconnects to the data conveying service server 750 after the determined 300 seconds period. Then at flow 17 the data conveying service server 750 sends stored messages/data to the data conveying service client 740.

Further, in accordance with the exemplary embodiments of the invention, a service, such as data conveying service, is allowed to select suitable connectivity method based on the information available about current and/or projected network conditions. In very poor networks for example the data conveying service can inform the client to use only polling and/or can instruct the client as to what would be a suitable polling frequency for the current cellular network. The polling frequency or usage of the always online connection may be tuned based on the statistical network load peak hours to obtain optimal balance between the allocated access network resources like a packet data protocol context or PDP CTX and network signaling load due setting up and/or freeing a PDP CTX as well as the lower protocol layer resources like a temporary block flow or TBF or spreading code allocations and/or handshaking needed by them. In some cases the client of the said data conveying service can utilize a hybrid of these two main connectivity methods—based on the needs of the applications using the said data conveying service.

The exemplary embodiments of the invention provide at least a method to perform novel operations including:
1. When connected—probe server tells the client optimal connectivity profile containing suggested polling frequency and keep alive interval. This profile will optionally include time intervals when to use which values and which method, such as polling or always online. Server will generally suggest a keep alive unless there is some data indicating either a need for a very frequent keep alive or network congestion at a given time [currently or projected in the future]. Additionally the probe server may suggest activity threshold values to revert to very low frequency polling mode or even disconnected mode.
2. The server may use various methods to determine the keep-alive period value, polling frequency, lazy re-connect time and combination of those and in ultimate case provide the scheme for the clients how to apply them dynamically based on the time and day of week. The profile may contain also inactivity thresholds to be utilized e.g. period with lights off and no key presses. The scheme may be advantageously composed from statistics and/or a preferred scheme may be obtained from the cellular operator. Further, a scheme may be customized for different radio access network (RAN) segment(s) based on the source IP range.
3. Client of the said data conveying service then combines the information about the connectivity needs of the applications in use, current or projected activity and the connectivity profile the client got from the probe server to decide how to connect to the data conveying service. The connectivity options include:
   a. Always online—when applications require near real time data and server suggests using always online connectivity.
   b. Intermittent connectivity—when applications allow some delay and server suggests always online or lazy-reconnect time.
   c. Polling—when server suggests polling.
   d. Very low frequency polling in case of activity below low frequency polling threshold value.
   e. Disconnect after if device activity is below the disconnect threshold.

As stated above, the exemplary embodiments of the invention provide a benefit including more reliable connections in poor cellular networks, and less data consumption and signaling load for operator networks. This is true especially in poor network conditions or during typical rush times to minimize risk of the access network is congestion, which may be a very valuable asset for co-operation with the cellular RAN operators.

FIG. 8A illustrates communications of devices and/or components in accordance with an exemplary embodiment of the invention. In flow 83C an assisting server or probe server 86 provides a connectivity profile to mobile client3. The client will use this connectivity profile when using a data conveying service. The connectivity profile can be based at least in part on network behavior data provided to the probe server 86 by mobile client1, mobile client2, and/or mobile client3 such as via communications 81C, 82C, and 83C, respectively. Further, as illustrated FIG. 8A the probe server 86 can receive the connectivity needs of APP1, APP2, and/or APP3 via mobile client4 and/or mobile client5. Thus, the assisting server/probe server 86 can consider these connectivity needs when sending connection instructions or data to the mobile clients 84 and/or 85. The assisting server/probe server 86 performs analysis of the data it receives and creates optimal connectivity profiles for the clients. Such as via the operators 1, 2, and/or 3. Further, the assisting server/probe server 86 can communicate with operator1, operator2, and/or operator3 to obtain connectivity profiles for any or all of the mobile clients. This can be performed, for example, over communications 88C, 89C, and/or 890C. The communication profiles can be provided to any or all of the clients, such as via the communications 81C, 82C, 83C, and/or 87C. Thus all applications using the data conveying service 80 for service1, service2, and/or service3 will automatically benefit from the optimal connectivity profiles, without their own internal processing expending additional resources. Such as for any or all of communications 810C, 820C, and 830C, 84C, 85C and/or 86C, as well as, communications 87C and 80C.

FIG. 8B is a diagram illustrating connectivity decisions in accordance with an exemplary embodiment of the invention. As illustrated in FIG. 8B, devices 1 and 2 are served by operator1 and the operator1 profile suggests using always online. The device1 has one application, APP1 with receive at latest value 600 seconds, and the device 1 receives instructions to use a lazy reconnect profile at latest 600 seconds, such as over communications 812C. Device2 has 2 applications (APP1 and APP2). The APP2 is always online and the device2 receives instructions to use always online profile, such as over communications 822C. Further, as illustrated in FIG. 8B, device3 and device4 are served by operator2 and the operator2 profile suggests using 600 seconds polling. The device 3 receives instructions/profile to use 600 seconds polling intervals, such as over communications 832C. Device4 receives via operator2 instructions to use 900 seconds polling intervals, such as over communications 842C.

According to one non-limiting embodiment of the invention from the perspective of the service platform there is a method, and an apparatus having at least one processor and a memory storing a computer program which all together are configured to cause the apparatus it perform actions, and a computer readable memory storing instructions that when executed cause an apparatus to perform the following:
receiving a connection instruction request from a user equipment;
identifying a network from which the request was sent.
selecting stored probe values and associated network information that are associated with the identified network;
determining connection instructions based at least in part on the stored probe values and the associated network information, in which the connection instructions include a dynamically extended reconnection delay if a determined keep-alive timer for keep-alive instructions would be impractically short; and
sending the connection instructions to the user equipment.

In a more particular aspect of the above embodiment, determining the connection instructions comprises using at least the selected stored probe values and associated network information to compose keep alive instructions, presence update instructions, dynamically extended reconnection delay, voluntary disconnection instructions, or combinations thereof. For example, as detailed above the connection instructions further comprise a maximum data packet size and maximum bit rate thresholds, above which would trigger a state change for the UE. In another example the keep alive instructions comprise a keep alive timer value determined from keep alive inactivity timers for nodes along a communications route between a service platform and a group of user equipments that are probed for the effective minimum combination of the said timers.

In another more particular aspect of the above embodiment, there is the additional step of determining that the selected stored probe values are insufficient and/or non-current, and in response tasking at least the UE to obtain new probe values and report results.

In a further particular aspect of the above embodiment, the service platform stores probe values and their associated network information in a probe database. The service platform then utilizes them in its determination of at least one of: keep-alive timer values, recommendations to delay re-connections, recommendations to voluntarily disconnect, data packet size, and bit rate threshold.

In a still further aspect of the above embodiment, the connection instructions comprise at least one of a suggested polling frequency, a keep alive interval, and a lazy reconnect time. In one of the embodiments detailed above the connection instructions further comprise a schedule to utilize different suggested polling frequencies or keep alive intervals or lazy reconnect times at different times of the day or week. Such a schedule may be dynamic and based on at least statistical information of network congestion at different times. As detailed above in one non-limiting aspect, this statistical information of the network congestion is determined via at least one of shortened keep-alive time probe values, an inability to get access grants when attempting to send the keep-alive probes, and losing connection to an access network at certain times of day or week.

In yet another particular aspect of the above embodiment, determining the probe values comprises requesting that one or more user equipment collect information comprising characteristics of a network connection.

In a still further aspect of the above embodiment, the connection instruction request identifies at least a cellular network to which the user equipment is associated or a source internet protocol address, and at least some of the stored probe values used to derive the connection instructions are associated with the identified cellular network or represent statistical congestion information associated with the identified source internet protocol address.

And in another aspect of the above embodiment, determining the connection instructions comprises using at least one of a narrower selection criteria based on an internet protocol address of the user equipment and a wider selection criteria based on network information associated with the request.

According to another non-limiting embodiment of the invention, for example from the perspective of the UE or from at least one server, there is a method, and an apparatus having at least one processor and a memory storing a computer program which all together are configured to cause the apparatus it perform actions, and a computer readable memory storing instructions that when executed cause an apparatus to perform the following:
determining a maximum packet size for which transmission will not trigger a state change for a UE; and
restricting transmissions of background data to or from the UE so as not to exceed the maximum packet size.

In a more particular aspect of this other embodiment, the background data comprises application data characterized in that transmission of said application data does not require end-user interaction.

In another more particular aspect of this other embodiment, the maximum packet size is limited by maximum throughput over time and is for transmissions on at least one of a forward access channel FACH, a paging channel PCH, and a random access channel (RACH); and the state change is from at least one of a CELL_FACH state, a CELL_PCH state, a URA_PCH state and an E-UTRA RRC idle state (for example, the UE may restrict its transmissions of background data on at least one of a FACH, a PCH, and a RACH). In one of the examples above the UE determines the maximum packet size from a broadcast channel, and in another example above the UE determines the maximum packet size by sending probe packets of increasing packet size until it is determined that the state change is triggered.

In a further particular aspect of this other embodiment, restricting transmissions of background data from the UE so as not to exceed the maximum packet size comprises testing whether an amount of data in a transmit buffer exceeds the maximum size, and if yes fragmenting the data in the transmit buffer into multiple messages for transmission such that none of the multiple messages exceeds the maximum packet size nor exceeds a maximum throughput when the messages are transmitted.

In a still further aspect of the above other embodiment from the perspective of server, such a server determines the maximum packet size by querying a database, and the server restricts the background data it sends to the UE so as not to exceed the maximum packet size.

In yet another particular aspect of this other embodiment, from the perspective of the server it determines the maximum packet size by tasking the UE to send probe packets of varying sizes and to report back packet size values that were tested for triggering the state change for the UE. And in a further aspect from the perspective of the server, it restricts the background data that it sends to the UE so as not to exceed the maximum packet size.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

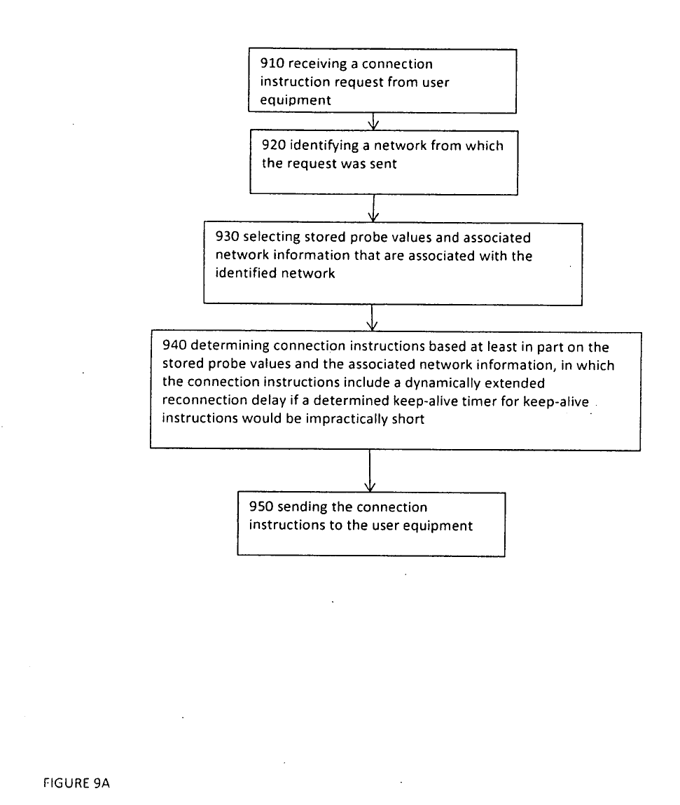

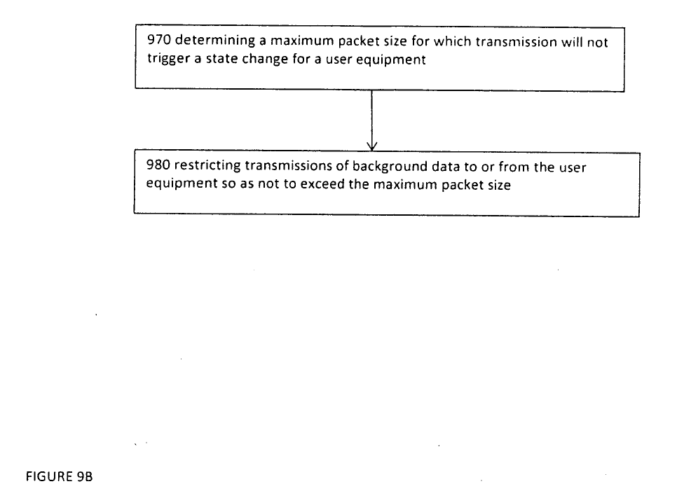

FIG. 9A and FIG. 9B are each a flow chart illustrating a method in accordance with the exemplary embodiments of the invention. Regarding FIG. 9A, as illustrated in block 910 there is receiving a connection instruction request from user equipment. As illustrated in block 920 there is identifying a network from which the request was sent. Then in block 930 there is selecting stored probe values and associated network information that are associated with the identified network. In block 940 of FIG. 9A there is determining connection instructions based at least in part on the stored probe values and the associated network information, in which the connection instructions include a dynamically extended reconnection delay if a determined keep-alive timer for keep-alive instructions would be impractically short. Then in block 950 there is sending the connection instructions to the user equipment.

Further, in accordance with the method of FIG. 9A the determining the connection instructions comprises using at least the selected stored probe values and associated network information to compose keep alive instructions, presence update instructions, dynamically extended reconnection delay, and voluntary disconnection instructions or combination there of

In accordance with the paragraphs above, the connection instructions further comprise a maximum data packet size and a maximum bit rate thresholds, above which would trigger a state change for the user equipment.

In accordance with the paragraphs above, the keep alive instructions comprise a keep alive timer value determined from keep alive inactivity timers for nodes along a communications route between a service platform executing the method and a group of user equipment probed the effective minimum combination of the said timers.

In accordance with the paragraphs above, there is determining that the selected stored probe values are insufficient and/or non-current and in response tasking at least the user equipment to obtain new probe values and report results.

Further, in accordance with the paragraphs above, the method is executed by a service platform which stores probe values and the associated network information in a probe database and utilizes them in determination of at least one of: keep-alive timer values, recommendations to delay re-connections, recommendations to voluntarily disconnect, data packet size and bit rate threshold.

Further, in accordance with the paragraphs above, the connection instructions comprise at least one of a suggested polling frequency, a keep alive interval, and a lazy reconnect time.

Further, in accordance with the paragraphs above, the connection instructions further comprise a schedule to utilize different suggested polling frequencies or keep alive intervals or lazy reconnect times at different times of day or week.

In accordance with the paragraphs above, the schedule is dynamic based on at least statistical information of network congestion at different times.

Further, in accordance with the paragraphs above, the statistical information of the network congestion is determined via at least one of shortened keep-alive time probe values, an inability to get access grants when attempting to send the keep-alive probes, and losing connection to an access network at certain times of day or week.

Further, in accordance with the paragraphs above, the determining the probe values comprises requesting that one or more user equipment collect information comprising characteristics of a network connection.

Further, in accordance with the paragraphs above, the connection instruction request identifies at least a cellular network to which the user equipment is associated or a source internet protocol address, and at least some of the stored probe values used to derive the connection instructions are associated with the identified cellular network or represent statistical congestion information associated with the identified source internet protocol address.

Further, in accordance with the paragraphs above, the determining the connection instructions comprises using at least one of a narrower selection criteria based on an internet protocol address of the user equipment and a wider selection criteria based on network information associated with the request

In accordance with the method as illustrated in FIG. 9B, at block 970 there is determining a maximum packet size for which transmission will not trigger a state change for a user equipment. Then at block 980 there is restricting transmissions of background data to or from the user equipment so as not to exceed the maximum packet size.

Further, in accordance with the method of FIG. 9B, the background data comprises application data characterized in that transmission of said application data does not require end-user interaction.

Further, in accordance with the paragraphs above, the maximum packet size is limited by maximum throughput over time and is for transmissions on at least one of a forward access channel FACH a paging channel PCH, and a random access channel (RACH); and the state change is from at least one of a CELL_FACH state, a CELL_PCH state, a URA_PCH state and an E-UTRA RRC idle state.

Further, in accordance with the paragraphs above, the method is executed by the user equipment which restricts transmissions of background data from the user equipment on at least one of a FACH, a PCH and a RACH.

Further, in accordance with the paragraphs above, the user equipment determines the maximum packet size from a broadcast channel.

Further, in accordance with the paragraphs above, the user equipment determines the maximum packet size by sending probe packets of increasing packet size until it is determined that the state change is triggered.

Further, in accordance with the paragraphs above, there is restricting transmissions of background data from the user equipment so as not to exceed the maximum packet size comprises testing whether an amount of data in a transmit buffer exceeds the maximum size and if yes fragmenting the data in the transmit buffer into multiple messages for transmission such that none of the multiple messages exceeds the maximum packet size nor exceeds a maximum throughput when the messages are transmitted.

Further, in accordance with the paragraphs above, in which the method is executed by at least one server which determines the maximum packet size by querying a database, and which restricts transmissions of background data to the UE so as not to exceed the maximum packet size.

Further, in accordance with the paragraphs above, in which the method is executed by at least one server which determines the maximum packet size by tasking the UE to send probe packets of varying sizes and to report back packet size values that were tested for triggering the state change for the UE, and which the at least one server restricts transmissions of background data to the UE so as not to exceed the maximum packet size.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
receiving a connection instruction request from user equipment;
identifying a network from which the request was sent;
selecting stored probe values and associated network information that are associated with the identified network;
determining connection instructions based at least in part on the stored probe values and the associated network information, in which the connection instructions include a dynamically extended reconnection delay if a determined keep-alive timer for keep-alive instructions would be impractically short; and
sending the connection instructions to the user equipment.

2. The method according to claim 1, where determining the connection instructions comprises using at least the selected stored probe values and associated network information to compose at least one of keep alive instructions, presence update instructions, dynamically extended reconnection delay, and voluntary disconnection instructions.

3. The method according to claim 2, in which the connection instructions further comprise a maximum data packet size and a maximum bit rate thresholds, above which would trigger a state change for the user equipment.

4. The method according to claim 2, where the keep alive instructions comprise a keep alive timer value determined from keep alive inactivity timers for nodes along a communications route between a service platform executing the method and a group of user equipment probed the effective minimum combination of the said timers.

5. The method according to claim 1, further comprising:
determining that the selected stored probe values are insufficient and/or non-current and in response tasking at least the user equipment to obtain new probe values and report results.

6. The method according to claim 1, where the method is executed by a service platform which stores probe values and the associated network information in a probe database and utilizes them in determination of at least one of: keep-alive timer values, recommendations to delay re-connections, recommendations to voluntarily disconnect, data packet size and bit rate threshold.

7. The method according to claim 1, where the connection instructions comprise at least one of a suggested polling frequency, a keep alive interval, and a lazy reconnect time.

8. The method according to claim 7, where the connection instructions further comprise a schedule to utilize different suggested polling frequencies or keep alive intervals or lazy reconnect times at different times of day or week.

9. The method according to claim 8, where the schedule is dynamic based on at least statistical information of network congestion at different times.

10. The method according to claim 9, where the statistical information of the network congestion is determined via at least one of shortened keep-alive time probe values, an inability to get access grants when attempting to send the keep-alive probes, and losing connection to an access network at certain times of day or week.

11. The method according to claim 1, where determining the probe values comprises requesting that one or more user equipment collect information comprising characteristics of a network connection.

12. The method according to claim 1, where the connection instruction request identifies at least a cellular network to which the user equipment is associated or a source internet protocol address, and at least some of the stored probe values used to derive the connection instructions are associated with the identified cellular network or represent statistical congestion information associated with the identified source internet protocol address.

13. The method according to claim 1, where determining the connection instructions comprises using at least one of a narrower selection criteria based on an internet protocol address of the user equipment and a wider selection criteria based on network information associated with the request.

14. The method according to claim 1 performed with a non-transitory computer readable memory storing instructions, the instructions executed by at least one processor.

15. An apparatus comprising:
at least one processor; and
at least one memory including computer program code, where the at least one memory and the computer program code are configured, with the at least one processor, to cause the apparatus to at least:
receive a connection instruction request from a user equipment;
identify a network from which the request was sent;
select stored probe values and associated network information that are associated with the identified network;
determine connection instructions based at least in part on the stored probe values and the associated network information, in which the connection instructions include a dynamically extended reconnection delay if a determined keep-alive timer for keep-alive instructions would be impractically short; and
send the connection instructions to the user equipment.

16. The apparatus according to claim 15, where determining the connection instructions comprises using at least the selected stored probe values and associated network information to compose at least one of keep alive instructions, presence update instructions, dynamically extended reconnection delay, and voluntary disconnection instructions.

17. The apparatus according to claim 16, where the connection instructions further comprise a maximum data packet size and a maximum bit rate thresholds, above which would trigger a state change for the user equipment.

18. The apparatus according to claim 16, where the keep alive instructions comprise a keep alive timer value determined from keep alive inactivity timers for nodes along a communications route between a service platform executing the method and a group of user equipment probed the effective minimum combination of the said timers.

19. The apparatus according to claim 15, where the at least one memory including the computer program code is configured with the at least one processor to cause the apparatus to:
determine that the selected stored probe values are insufficient and/or non-current and in response tasking at least the user equipment to obtain new probe values and report results.

20. The apparatus according to claim 15 comprising a service platform, where the at least one memory including the computer program code is configured with the at least one processor to cause the service platform to store probe values and the associated network information in a probe database and utilizes them in determination of at least one of: keep-alive timer values, recommendations to delay re-connections, recommendations to voluntarily disconnect, data packet size and bit rate threshold.

21. The apparatus according to claim 15, where the connection instructions comprise at least one of a suggested polling frequency, a keep alive interval, and a lazy reconnect time.

22. The apparatus according to claim 21, where the connection instructions further comprise a schedule to utilize different suggested polling frequencies or keep alive intervals or lazy reconnect times at different times of day or week.

23. The apparatus according to claim 22, where the schedule is dynamic based on at least statistical information of network congestion at different times.

24. The apparatus according to claim 23, where the statistical information of the network congestion is determined via at least one of shortened keep-alive time probe values, an inability to get access grants when attempting to send the keep-alive probes, and losing connection to an access network at certain times of day or week.

25. The apparatus according to claim 15, where determining the probe values comprises requesting that one or more user equipment collect information comprising characteristics of a network connection.

26. The apparatus according to claim 15, where the connection instruction request identifies at least a cellular network to which the user equipment is associated or a source internet protocol address, and at least some of the stored probe values used to derive the connection instructions are associated with the identified cellular network or represent statistical congestion information associated with the identified source internet protocol address.

27. The apparatus according to claim 15, where determining the connection instructions comprises using at least one of a narrower selection criteria based on an internet protocol address of the user equipment and a wider selection criteria based on network information associated with the request.

28. A method comprising:
determining a maximum packet size for which transmission will not trigger a state change for a user equipment; and
restricting transmissions of background data to or from the user equipment so as not to exceed the maximum packet size.

29. The method according to claim 28, in which the background data comprises application data characterized in that transmission of said application data does not require end-user interaction.

30. The method of claim 28, in which:
the maximum packet size is limited by maximum throughput over time and is for transmissions on at least one of a forward access channel FACH a paging channel PCH, and a random access channel (RACH); and
the state change is from at least one of a CELL_FACH state, a CELL_PCH state, a URA_PCH state and an E-UTRA RRC idle state.

31. The method according to claim 30, in which the method is executed by the user equipment which restricts transmissions of background data from the user equipment on at least one of a FACH, a PCH and a RACH.

32. The method according to claim 31, in which the user equipment determines the maximum packet size from a broadcast channel.

33. The method according to claim 31, in which the user equipment determines the maximum packet size by sending probe packets of increasing packet size until it is determined that the state change is triggered.

34. The method according to claim 28, in which restricting transmissions of background data from the user equipment so as not to exceed the maximum packet size comprises testing whether an amount of data in a transmit buffer exceeds the maximum size and if yes fragmenting the data in the transmit buffer into multiple messages for transmission such that none of the multiple messages exceeds the maximum packet size nor exceeds a maximum throughput when the messages are transmitted.

35. The method according to claim 28, in which the method is executed by at least one server which determines the maximum packet size by querying a database, and which restricts transmissions of background data to the user equipment so as not to exceed the maximum packet size.

36. The method according to claim 28, in which the method is executed by at least one server which determines the maximum packet size by tasking the user equipment to send probe packets of varying sizes and to report back packet size values that were tested for triggering the state change for the user equipment,
and which the at least one server restricts transmissions of background data to the user equipment so as not to exceed the maximum packet size.

37. The method according to claim 28 performed with a non-transitory computer readable memory storing instructions, the instructions executed by at least one processor.

38. An apparatus comprising:
at least one processor; and
at least one memory including computer program code, where the at least one memory and the computer program code are configured, with the at least one processor, to cause the apparatus to at least:
determine a maximum packet size for which transmission will not trigger a state change for a user equipment; and
restrict transmissions of background data to or from the user equipment so as not to exceed the maximum packet size.

39. The apparatus according to claim 38, in which the background data comprises application data characterized in that transmission of said application data does not require end-user interaction.

40. The apparatus according to claim 38, in which:
the maximum packet size is limited by maximum throughput over time and is for transmissions on at least one of a forward access channel FACH a paging channel PCH, and a random access channel (RACH); and
the state change is from at least one of a CELL_FACH state, a CELL_PCH state, a URA_PCH state and an E-UTRA RRC idle state.

41. The apparatus according to claim 38, comprising a user equipment, wherein the at least one memory including the computer program code is configured, with the at least one processor to cause the user equipment to restrict transmissions of background data from the user equipment on at least one of a FACH, a PCH and a RACH.

42. The apparatus according to claim 41, wherein the at least one memory including the computer program code is configured, with the at least one processor to cause the user equipment to determine the maximum packet size from a broadcast channel.

43. The apparatus according to claim 41, wherein the at least one memory including the computer program code is configured, with the at least one processor to cause the user equipment to determine the maximum packet size by sending probe packets of increasing packet size until it is determined that the state change is triggered.

44. The method according to any one of claim 41, in which restricting transmissions of background data from the user equipment so as not to exceed the maximum packet size, wherein the at least one memory including the computer program code is configured, with the at least one processor to cause the user equipment to test whether an amount of data in a transmit buffer exceeds the maximum size and if yes fragmenting the data in the transmit buffer into multiple messages for transmission such that none of the multiple messages exceeds the maximum packet size nor exceeds a maximum throughput when the messages are transmitted.

45. The apparatus according to claim 41, in which the method is executed by at least one server which determines the maximum packet size by querying a database, and which restricts transmissions of background data to the user equipment so as not to exceed the maximum packet size.

46. The apparatus according to claim 41, comprising at least one server, wherein the at least one memory including the computer program code is configured, with the at least one processor to cause the at least one server to determine the maximum packet size by tasking the user equipment to send probe packets of varying sizes and to report back packet size values that were tested for triggering the state change for the user equipment, and which the at least one server restricts transmissions of background data to the user equipment so as not to exceed the maximum packet size.
